(19) United States
(12) Patent Application Publication
(10) Pub. No.: US 2026/0016344 A1
(43) Pub. Date: Jan. 15, 2026

(54) PHOTONIC DEVICES WITH NESTED WAVEGUIDE ARRANGEMENTS

(71) Applicant: Apple Inc., Cupertino, CA (US)

(72) Inventors: Jason S. Pelc, Sunnyvale, CA (US); Jeremy D. Witmer, San Jose, CA (US); Lucia T. Gan, Mountain View, CA (US); Petr Markov, San Francisco, CA (US); Christopher M. Rogers, San Jose, CA (US)

(21) Appl. No.: 19/267,534

(22) Filed: Jul. 12, 2025

Related U.S. Application Data
(60) Provisional application No. 63/670,546, filed on Jul. 12, 2024.

(51) Int. Cl. G01J 9/02; G02B 6/293; G02B 6/42

(52) U.S. Cl. CPC G01J 9/02; G02B 6/4298; G01J 2009/0288; G02B 6/29352

(57) ABSTRACT

Embodiments are directed to photonic integrated circuits that include compact arrangements of Mach-Zehnder interferometers. Specifically, a Mach-Zehnder interferometer may include an input beam splitter and an output beam splitter that are configured to introduce light to and receive light from, respectively, a pair of intermediate waveguides. The Mach-Zehnder interferometer may be configured such that light enters and exits the pair of intermediate waveguides in different directions. Multiple Mach-Zehnder interferometers may be configured in this way and nested such that a pair of intermediate waveguides of one Mach-Zehnder interferometer may at least partially wrap around the intermediate waveguides of another Mach-Zehnder interferometer.

### CROSS-REFERENCE TO RELATED APPLICATIONS

This application claims the benefit under 35 U.S.C. § 119(e) of U.S. Provisional Patent Application No. 63/670,546, filed Jul. 12, 2024, the contents of which are incorporated herein by reference as if fully disclosed herein.

### FIELD

The described embodiments relate generally to photonic integrated circuits having nested waveguide arrangements. More specifically, the described embodiments are directed to photonic integrated circuits that include wavelength locking units having nested waveguide arrangements. For example, certain embodiments are directed to Mach-Zehnder interferometers and arrangements including multiple nested Mach-Zehnder interferometers.

### BACKGROUND

Mach-Zehnder interferometers are commonly used in photonic integrated circuits to generate interference patterns from light travelling within a photonic integrated circuit. Mach-Zehnder interferometers may be used for a variety of purposes within a photonic integrated circuit, such as to perform wavelength locking of a light source (e.g., a laser). In these instances, a Mach-Zehnder interferometer may receive light generated by a light source and may output a signal with an intensity that varies with the wavelength of the light generated by the light source. By measuring the intensity of the output the Mach-Zehnder interferometer, a photonic integrated circuit may be able to control the light source to maintain a particular emission wavelength. It may be possible, however, for other factors to impact the output of a Mach-Zehnder interferometer. For example, temperature gradients within a photonic integrated circuit may change the output of a Mach-Zehnder interferometer, which may impact the ability of the Mach-Zehnder interferometer's output to be used for wavelength locking. Accordingly, it may be desirable to compact Mach-Zehnder interferometers that have reduced sensitivity to temperature variations within a photonic integrated circuit.

### SUMMARY

Embodiments described herein are directed to photonic integrated circuits that include one or more Mach-Zehnder interferometers. Some embodiments are directed to a photonic integrated circuit that includes a light source configured to generate light, a wavelength locking unit configured to generate a plurality of output signals from a portion of the light, and a controller configured to use the plurality of output signals to control the light source to generate the light at a target wavelength. The wavelength locking unit includes a nested plurality of Mach-Zehnder interferometers configured to generate the plurality of output signal, such that each Mach-Zehnder interferometer of the nested plurality of Mach-Zehnder interferometers includes: a corresponding set of input waveguides, a corresponding set of output waveguides, a corresponding pair of intermediate waveguides, a corresponding input beam splitter connecting the corresponding set of input waveguides to the corresponding pair of intermediate waveguides in a first common direction, and a corresponding output beam splitter connecting the corresponding pair of intermediate waveguides to the corresponding set of output waveguides in a second common direction different than the first common direction. The wavelength locking unit may further include a plurality of detector elements configured to measure the plurality of output signals generated by the nested plurality of Mach-Zehnder interferometers.

In some variations, first common direction is opposite the second common direction. In some variations, each Mach-Zehnder interferometer of the nested plurality of Mach-Zehnder interferometers may include a first pair of rib-strip converters connecting the corresponding input beam splitter to the corresponding pair of intermediate waveguides. Additionally or alternatively, each Mach-Zehnder interferometer of the nested plurality of Mach-Zehnder interferometers may include a second pair of rib-strip converters connecting the corresponding pair of intermediate waveguides to the corresponding output beam splitter.

In some variations, the corresponding pair of intermediate waveguides for each Mach-Zehnder interferometer of the nested plurality of Mach-Zehnder interferometers includes a corresponding first intermediate waveguide having a corresponding first set of straight segments and a corresponding first set of bends and a corresponding second intermediate waveguide having a corresponding second set of straight segments and a corresponding second set of bends. In some of these variations, the corresponding first sets of bends and the corresponding second sets of bends of the nested plurality of Mach-Zehnder interferometers have a common configuration. The corresponding set of output waveguides of each Mach-Zehnder interferometer of the nested plurality of Mach-Zehnder interferometers may include a corresponding first output waveguide having a corresponding rib portion and a corresponding strip portion that connects the corresponding rib portion to the corresponding output beam splitter. In some of these variations, the corresponding rib portion of the corresponding first output waveguide of each Mach-Zehnder interferometer of the nested plurality of Mach-Zehnder interferometers includes a corresponding set of bends.

Other embodiments are directed toward a photonic integrated circuit that includes a light source configured to generate light, a wavelength locking unit configured to generate a plurality output signals, and a controller configured to use the plurality of output signals to control the light source to generate the light at a target wavelength. The wavelength locking unit includes a first Mach-Zehnder interferometer positioned to receive a first portion of the light and to generate a first output signal of the plurality of output signals, and a second Mach-Zehnder interferometer positioned to receive a second portion of the light and to generate a second output signal of the plurality of output signals. The first Mach-Zehnder interferometer includes: a first set of input waveguides, a first pair of intermediate waveguides, a first set of output waveguides, a first input beam splitter connecting the first set of input waveguides to the first pair of intermediate waveguides, and a first output beam splitter connecting the first pair of intermediate waveguides to the first set of output waveguides. The second Mach-Zehnder interferometer includes: a second set of input waveguides, a second pair of intermediate waveguides, a second set of output waveguides, a second input beam splitter connecting the second the set of input waveguides to the second pair of intermediate waveguides, and a second output beam splitter connecting the second pair of intermediate waveguides to the second set of output waveguides. The wavelength locking unit is configured such that a first portion of the second Mach-Zehnder interferometer is positioned between the first input beam splitter and the first output beam splitter.

In some variations, the wavelength locking unit includes a third Mach-Zehnder interferometer positioned to receive a first portion of the light and to generate a third output signal of the plurality of output signals. The third Mach-Zehnder interferometer may include: a third set of input waveguides, a third pair of intermediate waveguides, a third set of output waveguides, a third input beam splitter connecting the third the set of input waveguides to the third pair of intermediate waveguides, and a third output beam splitter connecting the third pair of intermediate waveguides to the second set of output waveguides. In some of these variations, a first portion of the third Mach-Zehnder interferometer is positioned between the second input beam splitter and the second output beam splitter. Additionally or alternatively, a second portion of the second Mach-Zehnder interferometer is positioned between the third output beam splitter and the third set of output waveguides. In some variations, a first portion of the first Mach-Zehnder interferometer is positioned between the second output beam splitter and the second set of output waveguides. Additionally, the wavelength locking unit may include a plurality of detector elements configured to measure the plurality of output signals generated by wavelength locking unit.

Still other embodiments are directed to a photonic integrated circuit having a nested of plurality of Mach-Zehnder interferometers that includes a first Mach-Zehnder interferometer and a second Mach-Zehnder interferometer. The first Mach-Zehnder interferometer includes: a first set of input waveguides, a first pair of intermediate waveguides, a first set of output waveguides, a first input beam splitter connecting the first set of input waveguides to the first pair of intermediate waveguides, and a first output beam splitter connecting the first pair of intermediate waveguides to the first set of output waveguides. The second Mach-Zehnder interferometer includes: a second set of input waveguides, a second pair of intermediate waveguides, a second set of output waveguides, a second input beam splitter connecting the second the set of input waveguides to the second pair of intermediate waveguides, and a second output beam splitter connecting the second pair of intermediate waveguides to the second set of output waveguides. The nested plurality of Mach-Zehnder interferometers is configured such that a first portion of the second Mach-Zehnder interferometer is positioned between the first input beam splitter and the first output beam splitter.

In some variations, the nested plurality of Mach-Zehnder interferometers includes a third Mach-Zehnder interferometer that includes: a third set of input waveguides, a third pair of intermediate waveguides, a third set of output waveguides, a third input beam splitter connecting the third the set of input waveguides to the third pair of intermediate waveguides, and a third output beam splitter connecting the third pair of intermediate waveguides to the second set of output waveguides. In some of these variations, a first portion of the third Mach-Zehnder interferometer is positioned between the second input beam splitter and the second output beam splitter. Additionally or alternatively, a second portion of the second Mach-Zehnder interferometer is positioned between the third output beam splitter and the third set of output waveguides. In some variations, a first portion of the first Mach-Zehnder interferometer is positioned between the second output beam splitter and the second set of output waveguides. In some of these variations, the first set of output waveguides includes an output waveguide having a first strip portion and a first rib portion, the second set of output waveguides includes an output waveguide having a second strip portion and second rib portion, and the first rib portion is positioned at least partially between the second rib portion and the second output beam splitter.

Other embodiments are directed to a photonic integrated circuit that includes a light source configured to generate light and a wavelength locking unit configured to generate a plurality of output signals from a portion of the light. The photonic integrated circuit includes a controller configured to use the plurality of output signals to control the light source to generate the light at a target wavelength. The wavelength locking unit includes a splitter configured to receive and split the portion of the light and includes a first splitter output and a second splitter output. The wavelength locking unit includes a two-by-three coupler configured to generate the plurality of output signals and includes a first coupler input, a second coupler input, a first coupler output, a second coupler output, and a third coupler output. The wavelength locking unit includes a first intermediate waveguide connecting the first splitter output to the first coupler input and a second intermediate waveguide connecting the first splitter output to the first coupler input. The two-by-three coupler is positioned at least partially between a first portion of the second intermediate waveguide and a second portion of the second intermediate waveguide.

In some variations, the splitter is positioned at least partially between the first portion of the second intermediate waveguide and the second portion of the second intermediate waveguide. Additionally or alternatively, the photonic integrated circuit may include a temperature sensor positioned to measure temperature at a location between the first portion of the second intermediate waveguide and the second portion of the second intermediate waveguide. In some of these variations, the location is positioned between the two-by-three coupler and the splitter along a direction.

In some variations, the first portion of the second intermediate waveguide includes a first straight section and a second straight section connected by a first turn, and the second portion of the second intermediate waveguide includes a third straight section and a fourth straight section connected by a second turn. In some of these variations, the photonic integrated circuit includes a first set of temperature sensors positioned to measure temperature at a first set of locations between the first straight section and the second straight section and a second set of temperature sensors positioned to measure temperature at a second set of locations between the third straight section and the fourth straight section. In some of these variations, the first set of temperature sensors includes a first temperature sensor and a second temperature sensor, and the second set of temperature sensors includes a third temperature sensor and a fourth temperatures sensor.

In some variations, the wavelength locking unit includes a first output waveguide connected to the first coupler output, a second output waveguide connected to the second coupler output, and a third output waveguide connected to the third coupler output. In some of these variations, the two-by-three coupler includes i) a first coupler waveguide connecting the first coupler input to the first coupler output, ii) a second coupler waveguide connecting the second coupler input to the second coupler output, and iii) a third coupler waveguide connected to the third coupler output, where the third coupler waveguide is optically coupled to each of the first coupler waveguide and the second coupler waveguide. Additionally or alternatively, the second portion of the second intermediate waveguide may be at least partially positioned between the two-by-three coupler and a first portion of the first output waveguide.

Yet other embodiments are directed to a photonic integrated circuit that includes a splitter configured to receive and split a portion of light, where the splitter includes a first splitter output and a second splitter output. The photonic integrated circuit includes a coupler configured to generate the plurality of output signals and including a first coupler input, a second coupler input, and a plurality of coupler outputs. The photonic integrated circuit includes a first intermediate waveguide connecting the first splitter output to the first coupler input and a second intermediate waveguide connecting the first splitter output to the first coupler input. The coupler is positioned at least partially between a first portion of the second intermediate waveguide and a second portion of the second intermediate waveguide, and the splitter is positioned at least partially between the first portion of the second intermediate waveguide and the second portion of the second intermediate waveguide.

In some variations, the coupler is a two-by-three coupler, such that the plurality of coupler outputs includes a first coupler output, a second coupler output, and a third coupler output. In some of these variations, the two-by-three coupler includes: i) a first coupler waveguide connecting the first coupler input to the first coupler output, ii) a second coupler waveguide connecting the second coupler input to the second coupler output, and iii) a third coupler waveguide connected to the third coupler output, where the third coupler waveguide is optically coupled to each of the first coupler waveguide and the second coupler waveguide.

In some variations, the photonic integrated circuit may include a temperature sensor positioned to measure temperature at a location between the first portion of the second intermediate waveguide and the second portion of the second intermediate waveguide. In some of these variations, the location is positioned between the two-by-three coupler and the splitter along a direction. In some variations, the photonic integrated circuit includes a plurality of output waveguides connected to the plurality of coupler outputs. In some of these variations, the second portion of the second intermediate waveguide is at least partially positioned between the two-by-three coupler and a first portion of the plurality of output waveguides.

In some variations, the first portion of the second intermediate waveguide includes a first straight section and a second straight section connected by a first turn, and the second portion of the second intermediate waveguide includes a third straight section and a fourth straight section connected by a second turn. In some of these variations, the photonic integrated circuit includes a first set of temperature sensors positioned to measure temperature at a first set of locations between the first straight section and the second straight section and a second set of temperature sensors positioned to measure temperature at a second set of locations between the third straight section and the fourth straight section. In some of these variations, the first set of temperature sensors includes a first temperature sensor and a second temperature sensor, and the second set of temperature sensors includes a third temperature sensor and a fourth temperatures sensor.

In addition to the example aspects and embodiments described above. further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a schematic view of a photonic integrated circuit that includes a Mach-Zehnder interferometer.

FIG. 2 shows a schematic view of a photonic integrated circuit that includes a wavelength locking unit that incorporates a set of Mach-Zehnder interferometers.

FIG. 3 shows a top view of a portion of a photonic integrated circuit that includes a variation of Mach-Zehnder interferometer as described herein.

FIG. 4 shows a top view of a portion of a photonic integrated circuit that includes a nested plurality of Mach-Zehnder interferometers.

FIG. 5 shows a schematic view of a photonic integrated circuit that includes a wavelength locking unit that incorporates a nested interferometric arrangement.

FIG. 6A shows a top view of a portion of a photonic integrated circuit that includes a nested interferometric arrangement. FIGS. 6B and 6C show top views of variations of the photonic integrated circuit of FIG. 6A in which the nested interferometric arrangement further includes corresponding sets of temperature sensors.

It should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Described herein are photonic integrated circuits that incorporate nested waveguide arrangements. For example, some variations of the photonic integrated circuits described herein include a wavelength locking unit that incorporates a nested waveguide arrangement. The wavelength locking unit may assist in controlling the operation of a light source (e.g., to control a wavelength emitted by the light source to a target wavelength). The use of a nested waveguide arrangement may help reduce the impact of localized temperature variations (e.g., temperature gradients) that may occur in the photonic integrated circuit (e.g., in a vicinity of a wavelength locking unit that incorporates the nested waveguide arrangement).

Some embodiments disclosed herein are directed toward photonic integrated circuits that include a Mach-Zehnder interferometers (also referred to herein as “MZI”), arrangements of MZIs, or wavelength locking units that incorporate arrangements of MZIs. Specifically, the MZIs described herein may include an input beam splitter and an output beam splitter that are configured to introduce light to and receive light from, respectively, a pair of intermediate waveguides. The MZIs may be configured such that light enters and exits the pair of intermediate waveguides in different directions. Additionally, multiple MZIs configured in this way may be nested such that a pair of intermediate waveguides of one MZI may at least partially wrap around a pair of intermediate waveguides of another MZI. This may allow for reduced spacing between the intermediate waveguides of a given MZI, as well as between the pairs of intermediate waveguides of different MZIs, which may reduce the overall footprint of these MZIs.

Other embodiments disclosed herein are directed to photonic integrated circuits that include an interferometric arrangement that includes a splitter, a coupler, and a pair of intermediate waveguides that connects the splitter to the coupler. The interferometric arrangement is configured to receive light (e.g., emitted by a light source) and to generate a plurality of output signals, where each output signal has a corresponding intensity that depends at least in part on the wavelength of the light received by the interferometric arrangement. The pair of intermediate waveguides is configured to provide a phase delay differential between the splitter and the coupler, and one of the pair of intermediate waveguides is configured to at least partially wrap around the coupler. This may help to reduce the impact of temperature gradients on the output signals generated by the interferometric arrangement.

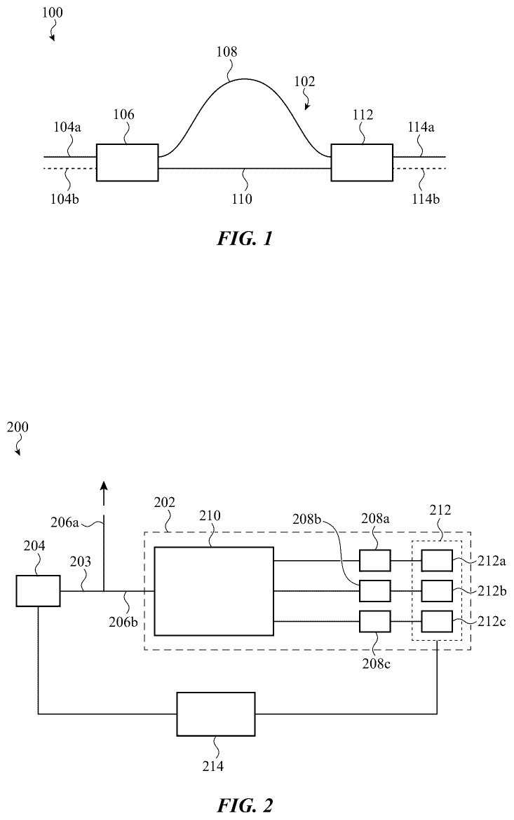

These and other embodiments are discussed below with reference to FIGS. 1-6C. However, those skilled in the art will readily appreciate that the detailed description given herein with respect to these Figures is for explanatory purposes only and should not be construed as limiting.

FIG. 1 depicts a schematic view of a photonic integrated circuit 100 that includes an MZI 102. The MZI 102 includes a set of input waveguides 104a-104b, a pair of intermediate waveguides (e.g., a first intermediate waveguide 108 and a second intermediate waveguide 110), and a set of output waveguides 114a-114b. The MZI 102 includes an input beam splitter 106 connecting the set of input waveguides 104a-104b to the first intermediate waveguide 108 and the second intermediate waveguide 110. The MZI 102 further includes an output beam splitter 112 connecting the first intermediate waveguide 108 and the second intermediate waveguide 110 to the set of output waveguides 114a-114b. In this way, the first intermediate waveguide 108 and the second intermediate waveguide 110 optically couple the input beam splitter 106 to the output beam splitter 112.

The set of input waveguides 104a-104b includes at least a first input waveguide 104a. In some variations, the set of input waveguides 104a-104b further includes a second input waveguide 104b. Similarly, the set of output waveguides 114a-114b includes at least a first output waveguide 114a. In some variations, the set of output waveguides 114a-114b further includes a second output waveguide 114b. When light (also referred to herein as “input light”) is received at one of the set of input waveguides 104a-104b (e.g., at the first input waveguide 104a), the MZI 102 will output a corresponding output signal at each output waveguide of the set of output waveguides 114a-114b. Each output signal will have a corresponding intensity, where the intensity depends at least in part on the wavelength of the input light.

Specifically, the input beam splitter 106 is configured to split light received by each of the set of input waveguides 104a-104b, such that the light is split between the first intermediate waveguide 108 and the second intermediate waveguide 110. The input beam splitter 106 may be a 1×2 beam splitter with a single input and two outputs (e.g., in variations where the MZI 102 has a single first input waveguide 104a) or may be a 2×2 beam splitter with two inputs and two outputs (e.g., in variations where the MZI 102 has a first input waveguide 104a and a second input waveguide 104b). Similarly, the output beam splitter 112 is configured to couple light from the first intermediate waveguide 108 and the second intermediate waveguide into the set of output waveguides 114a-114b. The output beam splitter 112 may be 2×1 beam splitter with two inputs and a single output (e.g., in variations where the MZI 102 has a single first output waveguide 114a) or may be a 2×2 beam splitter with two inputs and two outputs (e.g., in variations where the MZI 102 has a first output waveguide 114a and a second output waveguide 114b). The input beam splitter 106 and the output beam splitter 112 may each be any suitable beam splitting component, such as a y branch splitter, directional coupler, multimode interferometer, or the like.

The first intermediate waveguide 108 and the second intermediate waveguide 110 may be configured to provide a relative phase shift for light traveling in the first intermediate waveguide 108 and the second intermediate waveguide 110. For example, the first intermediate waveguide 108 may have a longer length than the second intermediate waveguide 110, such that light traveling through the first intermediate waveguide 108 experiences a phase delay relative to light traveling through the second intermediate waveguide 110. Accordingly, when input light is introduced into an input waveguide of the MZI 102, the input beam splitter 106 couples a first split portion of the input light into the first intermediate waveguide 108 and a second portion of the input light into the second intermediate waveguide 110. As the first and second portions of the input light reach the output beam splitter 112, the first portion of the input light will be phase-shifted relative to the second portion of the input light. The output beam splitter 112 will couple light from the first intermediate waveguide 108 and the second intermediate waveguide 110 into each of the set of output waveguides 114a-114d. Accordingly, each output signal generated by the MZI 102 is based on interference between the first and second portions of the input light carried as it is coupled into a corresponding output waveguide.

The amount of this interference, and thereby the intensity of a given output signal, depends on the phase difference between the first and second portions of the input light as they reach the output beam splitter 112. Because this phase difference depends at least in part on the wavelength of the input light, the magnitude of each output signal generated by the MZI 102 will depend at least in part on the wavelength of the input light received by an input waveguide of the MZI 102. This wavelength dependency may be utilized in helping to control the wavelength of a light source.

For example, FIG. 2 shows a photonic integrated circuit 200 that includes a wavelength locking unit 202 that may be utilized to control the operation of a light source 204 that is configured to generate light. The light source 204 may be any component capable of generating light at one or more particular wavelengths, such as a laser. A laser may include a semiconductor laser, such as a laser diode (e.g., a distributed Bragg reflector laser, a distributed feedback laser, an external cavity laser), a quantum cascade laser, or the like. The light source 204 may be single-frequency (fixed wavelength) or may be tunable to selectively generate one of multiple wavelengths (e.g., the light source may be controlled to output different wavelengths at different times). It should be appreciated that wavelength of some single-frequency light sources may still be tuned over a relatively small tuning range (e.g., one the order of less than a nanometer or single nanometers), whereas tunable light sources may be tuned over a wider range (e.g., on the order of tens or hundreds of nanometers). The photonic integrated circuit 200 may include a controller 214 that uses feedback from the wavelength locking unit 202 to control the wavelength of light generated by the light source 204. For example, the controller 214 may select a target wavelength, depending on a desired operation of the photonic integrated circuit 200, and may control the light source 204 to output light at the target wavelength.

A portion of the light generated by the light source 204 may be routed to the wavelength locking unit 202. For example, light generated by the light source 204 may be carried by a waveguide 203 and light from the waveguide 203 may be split (e.g., using a tap) into a first output 206a and a second output 206b. Light in the first output 206a may be directed to another portion of photonic integrated circuit 200, such that this light may be used by the photonic integrated circuit 200 for other purposes. The light in the second output 206b (also referred to herein as “measured light”) may be routed to the wavelength locking unit 202. It should be appreciated that the second output 206b may be split from any location within the layout the photonic integrated circuit 200, and thus the wavelength locking unit 202 may be used to measure light at that particular location. Light generated by the light source 204 may, in some instances may pass through and/or interact with a range of additional optical components (e.g., multiplexers, splitters, phase shifters, filters, amplifiers, modulators or the like) before reaching the wavelength locking unit 202. Accordingly, the controller 214 may control the light source 204 such that the light emitted by light source 204, when measured at a particular location in the photonic integrated circuit 200, has the target wavelength.

While a single light source 204 is shown in FIG. 2, it should be appreciated that the wavelength locking unit 202 may be used to control a plurality of light sources. For example, the wavelength locking unit 202 may be optically connected to multiple light sources, such that the wavelength locking unit 202 may measure light generated by multiple light sources. During a first period of time, a first light source (e.g., light source 204) may generate light and a portion of that light may be routed to the wavelength locking unit 202. While the first light source is generating light during the first period of time, the controller 214 may use feedback from the wavelength locking unit 202 to control the first light source to generate light a first target wavelength. A second light source may generate light during a subsequent second period of time, and a portion of that light may be routed to the wavelength locking unit 202. During the second period of time, the controller 214 may use feedback from the wavelength locking unit 202 to control the second light source to generate a second target wavelength. In instances where the wavelength locking unit 202 is used to control the operation of multiple light sources, the wavelength locking unit 202 may receive light from these light sources from different locations in the photonic integrated circuit 200 or from a common location in the photonic integrated circuit 200 as may be desired. The operation of the wavelength locking unit 202 is described herein with respect to light source 204, though it should be appreciated that the wavelength locking unit 202 may be similarly operated to control the operation of any other light sources as may be desired.

The wavelength locking unit 202 is configured to generate a set of output signals from the portion of the light received from the light source 204. The wavelength locking unit 202 includes a set of MZIs 208a-208c, each of which is configured to receive a corresponding portion of light generated by the light source 204 and generate a corresponding output signal, such as described herein with respect to the MZI 102 of FIG. 1. The wavelength locking unit 202 further includes a detector 212 having a set of detector elements 212a-212c configured to measure the set of output signals. Specifically, each of the set of detector elements 212a-212c is positioned to measure a corresponding output signal of a corresponding MZI of the set of MZIs 208a-208c. The controller 214 may be connected to the detector 212 to receive the measured output signals from the set of detector elements 212a-212c. Each output signal will have a corresponding intensity that varies as a function of the wavelength of the measured light. As the wavelength of light generated by the light source 204 deviates from the target wavelength, the intensities of the output signals generated by the set of MZIs 208a-208c will also change. Accordingly, the controller 214 may, upon detecting these changes to the intensities of the output signals (e.g., as generated by the set of MZIs 208a-208c and measured by the set of detector elements 212a-212c), adjust the wavelength of the light source 204 to correct for this deviation.

While the set of MZIs 208a-208c may include a single MZI, it may be desirable for the set of MZIs 208a-208c to include a plurality of MZIs. Specifically, the intensity of an output signal of an MZI varies sinusoidally with wavelength, and thus the slope of this intensity-wavelength relationship may also vary sinusoidally. Accordingly, it may be harder to accurately control a light source for target wavelengths that fall near the local minimums in this intensity-wavelength relationship (as compared to target wavelengths that fall near the local maximums), as the same change in wavelength will result in a relatively smaller change in the intensity of the output signal. When the wavelength locking unit 202 includes a plurality of MZIs, different MZIs may be configured to have different intensity-wavelength relationships. For example, the set of MZIs 208a-208c may include a first MZI 208a that generates a first output signal having a first intensity-wavelength relationship, a second MZI 208b that generates a second output signal having a second intensity-wavelength relationship that is phase-shifted relative to the first intensity-wavelength relationship, and a third MZI 208c that generates a third output signal having a third intensity-wavelength relationship that is phase-shifted relative to each of the first intensity-wavelength relationship and the second intensity-wavelength relationship. In these instances, the corresponding intensity-wavelength relationships of the first, second, and third output signals will have local maximums at different wavelengths. For any given target wavelength, at least one of the output signals will be at or near a local maximum.

The set of detector elements 212a-212c may include a first detector element 212a optically connected to an output waveguide of the first MZI 208a to measure the first output signal, a second detector element 212b optically connected to an output waveguide of the second MZI 208b to measure the second output signal, and a third detector element 212c optically connected to an output waveguide of the third MZI 208c to measure the third output signal. The controller 214 may receive the measured output signals from the set of detector elements 212a-212c and use these measured output signals to control the light source 204 to a target wavelength. In analyzing the measured output signals, the controller 214 may prioritize output signals that are closer to local maximums of their corresponding intensity-wavelength relationships. As a result, different output signals may be prioritized for different target wavelengths. Overall, the wavelength locking unit 202 may be used to accurately perform wavelength locking across a wide range of target wavelengths.

In instances when a wavelength locking unit 202 includes a plurality of MZIs 208a-208c, the wavelength locking unit 202 may include a set of splitters 210 that connect the second output 206b to the plurality of MZIs 208a-208c. Specifically, the set of splitters 210 receives the measured light and divides the measured light into multiple portions corresponding to the plurality of MZIs 208a-208c. Specifically, the set of splitters 210 (which may include a single splitter or multiple cascaded splitters) has at least a plurality of outputs, each of which is optically connected to a corresponding MZI of the plurality of MZIs 208a-208c. In this way, each MZI of the plurality of MZIs 208a-208c may receive, as input light for the MZI, a different portion of the measured light.

When the wavelength locking unit 202 includes a plurality of MZIs 208a-208c, the individual MZIs may be arranged in a manner that allows for different length differences between the corresponding intermediate waveguides of each MZI. Depending on the configuration of the MZIs 208a-208c, the plurality of MZIs 208a-208c may have a relatively large footprint within the photonic integrated circuit 200. For example, if each of the plurality of MZIs 208a-208c is configured as shown in relation to the MZI 102 of FIG. 1, the plurality of MZIs 208a-208c may be positioned in a side-by-side arrangement. In these instances, localized temperature variations (such as a temperature gradients) within the photonic integrated circuit 200 may differentially impact the plurality of MZIs 208a-208c. Changing the temperature of a portion of waveguide changes its refractive index, and thus localized temperature variations may change the phase delay provided by the intermediate waveguides of an MZI. Fluctuations in this phase delay may also cause fluctuations in the phase of intensity-wavelength relationship of the output signal generated by that MZI. Additionally, changing the phase delay of one MZI relative to another MZI (e.g., due to temperature differences experienced by the plurality of MZIs 208a-208c) may change the relative phases of the intensity-wavelength relationships of the corresponding output signals. It may be possible for temperature changes, such as from a temperature gradient, to reduce the phase difference between the intensity-wavelength relationships of the output signals generated by the plurality of MZIs 208a-208c, which may limit the accuracy of the wavelength locking unit 202 at certain target wavelengths.

The wavelength locking systems described herein utilize compact MZI layouts. Reducing the footprint of an individual MZI, as well as the overall footprint of a plurality of MZIs, will reduce the susceptibility of these MZIs to temperature fluctuations. Specifically, the MZI layouts described herein include MZIs that each include a set of bends that are configured to change the direction of the intermediate waveguides of these waveguides. In these instances, the input beam splitter and the output beam splitter of an MZI may be oriented in different directions, such that the set of input waveguides enter the input beam splitter along a different direction than the set of output waveguides exit the output beam splitter. Multiple of these MZIs may be nested to form a nested plurality of MZIs with a relatively small footprint. A nested plurality of MZIs may be incorporated in the wavelength locking unit 202 (e.g., in place of the MZIs 208a-208c) to generate a plurality of output signals.

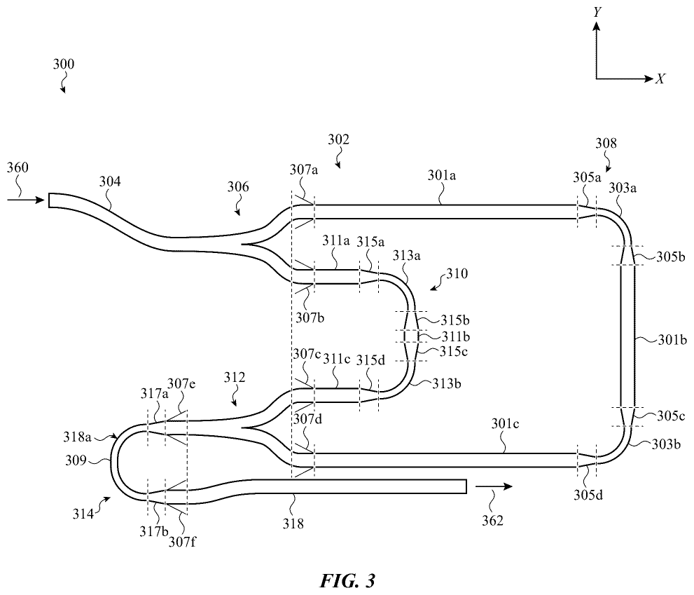

FIG. 3 shows a variation of a photonic integrated circuit 300 that includes a MZI 302 that may be incorporated into a nested plurality of MZIs as described herein. The MZI 302 includes a set of input waveguides (depicted in FIG. 3 as a single input waveguide 304), a pair of intermediate waveguides 308, 310 that includes a first intermediate waveguide 308 and a second intermediate waveguide 310, and a set of output waveguides (depicted in FIG. 3 as a single output waveguide 314). While the MZI 302 is shown in FIG. 3 as having a single input waveguide 304 and a single output waveguide 314, the MZI 302 may alternatively have a second input waveguide and/or a second output waveguide such as described herein with respect to FIG. 1. The MZI 302 also includes an input beam splitter 306 that connects each of the set of input waveguides to the pair of intermediate waveguides 308, 310. Input light 360 received by an input waveguide (e.g., input waveguide 304) of the set of input waveguides will be split between the first intermediate waveguide 308 and the second intermediate waveguide 310. The MZI 302 includes an output beam splitter 312 that connects the pair of intermediate waveguides 308 to the set of output waveguides. Specifically, light carried by the first intermediate waveguide 308 and the second intermediate waveguide 310 is coupled into the set of output waveguides (e.g., output waveguide 314) to generate a set of output signals. For example, the MZI 302 may generate a first output signal 362 at output waveguide 314. In variations in which the MZI 302 includes a second output waveguide (not shown), the MZI 302 may generate a second output signal at the second output waveguide.

The input beam splitter 306 and the output beam splitter 312 of the MZI 302 may be oriented to couple light in different directions. Specifically, the input beam splitter 306 connects the set of input waveguides to the pair of intermediate waveguides 308, 310 in a first direction (e.g., from the left to the right along the X axis shown in FIG. 3). Specifically, light entering and exiting the input beam splitter 306 will travel along the first direction. Conversely, the output beam splitter 312 connects the pair of intermediate waveguides 308, 310 to the set of output waveguides in a second direction (e.g., from the right to the left along the X axis shown in FIG. 3) that is different from the first direction, such that light entering and exiting the output beam splitter 312 will travel along the second direction. In some variations, the first direction is opposite the second direction, such that light will enter and exit the pair of intermediate waveguides 308, 310 in opposite directions.

Accordingly, each of the pair of intermediate waveguides 308, 310 may be configured to redirect light traveling between the input beam splitter 306 and the output beam splitter 312. Specifically, the first intermediate waveguide 308 and the second intermediate waveguide 310 are configured to wind in a common winding direction (e.g., a clockwise direction as shown in FIG. 3) between the input beam splitter 306 and the output beam splitter 312. The first intermediate waveguide 308 includes a first set of straight segments 301a-301c and a first set of bends 303a-303b and the second intermediate waveguide 310 includes a second set of straight segments 311a-311c and a second set of bends 313a-313b.

In the variation shown in FIG. 3, the first set of straight segments 301a-301c includes three straight segments (e.g., a first straight segment 301a, a second straight segment 301b, and a third straight segment 301c) and the first set of bends 303a-303b includes two bends (e.g., a first bend 303a and a second bend 303b). In these variations, the first bend 303a connects the first straight segment 301a to the second straight segment 301b, and the second bend 303b connects the second straight segment 301b to the third straight segment 301c. Accordingly, light introduced into the first intermediate waveguide 308 from the input beam splitter 306 passes sequentially through the first straight segment 301a, the first bend 303a, the second straight segment 301b, the second bend 303b, and the third straight segment 301c of the first intermediate waveguide 308 before reaching the output beam splitter 312.

Similarly, the second set of straight segments 311a-311c includes three straight segments (e.g., a first straight segment 311a, a second straight segment 311b, and a third straight segment 311c) and the second set of bends 313a-313b includes two bends (e.g., a first bend 313a and a second bend 313b). In these variations, the first bend 313a connects the first straight segment 31 la to the second straight segment 311b, and the second bend 313b connects the second straight segment 311c to the third straight segment 311c. Accordingly, light introduced into the second intermediate waveguide 310 from the input beam splitter 306 passes sequentially through the first straight segment 311a, the first bend 313a, the second straight segment 311b, the second bend 313b, and the third straight segment 311c of the second intermediate waveguide 310 before reaching the output beam splitter 312.

In some variations, each straight segment of the first set of straight segments 301a-301c is parallel to a corresponding straight segment of the second set of straight segments 311a-311c. For example, in the variation shown in FIG. 3, the first straight segment 301a of the first set of straight segments 301a-301c is parallel to the first straight segment 311a of the second set of straight segments 311a-311c. The second straight segment 301b of the first set of straight segments 301a-301c may be parallel to the second straight segment 311b of the second set of straight segments 311a-311c. The third straight segment 301c of the first set of straight segments 301a-301c may be parallel to the third straight segment 311c of the second set of straight segments 311a-311c, which may also be parallel to the first straight segment 301a of the first set of straight segments 301a-301c and the first straight segment 311a of the second set of straight segments 311a-311c. Such an arrangement may allow for reduced spacing between the pair of intermediate waveguides 308, 310.

In some variations, it may be desirable for each bend of the first set of bends 303a-303b to have a common configuration as a corresponding bend of the second set of bends 313a-313b. When two bends are described herein as having a “common configuration”, the two bends have the same dimensions (e.g., width and length) and curvature. To the extent that the width and/or curvature varies along the length of a first bend, such as in the instance of an Euler bend, a second bend with a common configuration will have a matching variation in the width and/or curvature along its length. For example, the first bend 303a of the first set of bends 303a-303b and the first bend 313a of the second set of bends 313a-313b may have a first common configuration. Similarly, the second bend 303b of the first set of bends 303a-303b and the second bend 313b of the second set of bends 313a-313b may have a second common configuration. In some variations, the first common configuration is different than the second common configuration, such that i) the first bend 303a and the second bend 303b of the first set of bends 303a-303b have different configurations, and ii) the first bend 313a and the second bend 313b of the second set of bends 313a-313b have different configurations. In other variations, the first common configuration is the same as the second common configuration, such that all of the bends of the first set of bends 303a-303b and the second set of bends 313a-313b have a common configuration.

Matching the configurations between the bends of the first intermediate waveguide 308 and the second intermediate waveguide 310 may reduce differences in parasitic modes generated by the corresponding bends of these waveguides. The photonic integrated circuit 300 may be configured such that the MZI 302 receives input light 360 having a first mode and a first polarization (e.g., TE00), referred to herein as the “input mode.” As the input light travels through the MZI 302, some of the light will be converted from the input mode to a higher order mode and/or a different polarization (e.g., from TE00 to some or all of TM00, TM10, TE01, and TE10) as it travels through any given bend of the first set of bends 303a-303b or the second set of bends 313a-313b. These different modes and/or polarization states are collectively referred to herein as “parasitic modes,” and these parasitic modes may impact the output signals generated by the MZI 302 (e.g., the first output signal 362). Specifically, differences between the intensity and number of parasitic modes generated in the first intermediate waveguide 308 as compared to those generated in the second intermediate waveguide 310 may negatively impact one or more characteristics of the intensity-wavelength relationship of the output signals generated by the MZI 302. Configuring each bend of the first set of bends 303a-303b to have a common configuration as a corresponding bend of the second set of bends 313a-313b may help reduce these differences.

Within a waveguide bend, the amount of light that couples into different parasitic modes increases as a function of waveguide width for a given bend radius. Increasing the bend radius of the bends will also increase the size of the MZI 302, and thus the MZI 302 may utilize relatively small bends in the pair of output waveguides 308, 310 to prioritize a smaller form factor. As a result, it may be desirable to reduce a width of the waveguide in each bend to reduce the parasitic losses that are generated. Because propagation losses increase with decreasing waveguide width, a corresponding reduction in the width of the straight segments would increase propagation losses in the straight segments.

Accordingly, it may be desirable for the MZI 302 to be configured such that the corresponding straight segments of the pair of output waveguides 308, 310 are wider than the corresponding bends of the pair of output waveguides 308, 310. This allows the MZI 302 to prioritize reducing different types of loss in different regions (e.g., prioritizing reduction of parasitic losses in the bends and prioritizing the reduction of propagation losses in the straight segments), each of which may impact the intensity-wavelength relationships of the output signal generated by the MZI 302. For example, in the variation shown in FIG. 3, each straight segment of the first set of straight segments 301a-301c is wider than each bend of first set of bends 303a-303b and each straight segment of the second set of straight segments 311a-311c is wider than each bend of the second set of bends 313a-313b. In some of these variations, the first set of straight segments 301a-301c and the second set of straight segments 311a-311c each have a common first width, and the first set of bends 303a-303b and the second set of bends 313a-313b each have a common second width that is narrower than the first width.

In order to facilitate the change in width between a straight segment and a bend, each of the pair of intermediate waveguides 308, 310 may include a corresponding set of tapers. Specifically, the first intermediate waveguide 308 includes a first set of tapers 305a-305d and the second intermediate waveguide 310 includes a second set of tapers 315a-315d. Each taper may be positioned between a corresponding straight segment and bend and may have a width that narrows from the wider width of that straight segment to the narrower width of that bend. For example, in instances where the straight segments have a common first width and the bends have a common second width, each of the first set of tapers 305a-305d and second set of tapers 315a-315d may have a corresponding width that varies from the first width to the second width. Additionally, each taper may be adiabatic so as not to excite parasitic modes. In the variation shown in FIG. 3, the first set of tapers 305a-305d of the first intermediate waveguide 308 may include a first taper 305a connecting the first straight segment 301a to the first bend 303a, a second taper 305b connecting the first bend 303a to the second straight segment 301b, a third taper 305c connecting the second straight segment 301b to the second bend 303b, and a fourth taper 305d connecting the second bend 303b to the third straight segment 301c. Similarly, the second set of tapers 315a-315d of the second intermediate waveguide 318 may include a first taper 315a connecting the first straight segment 311a to the first bend 313a, a second taper 315b connecting the first bend 313a to the second straight segment 311b, a third taper 315c connecting the second straight segment 311b to the second bend 313b, and a fourth taper 315d connecting the second bend 313b to the third straight segment 311c.

In some variations, it may be desirable to configure certain portions of the MZI 302 using rib waveguides and other portions of the MZI 302 using strip waveguides. In the variation shown in FIG. 3, the pair of intermediate waveguides 308, 310 are configured as strip waveguides and the input beam splitter 306 and the output beam splitter 312 are each formed using rib waveguides. For example, each of the input beam splitter 306 and the output beam splitter 312 are configured in FIG. 3 as a rib waveguide y-branch splitter, though it should be appreciated that other beam splitters may be formed from rib waveguides. In these variations, the MZI 302 may include a set of rib-strip converters 307a-307f that transition between portions of the MZI 302 that are configured as rib waveguides and portions that are configures as strip waveguides. Specifically, the set of rib-strip converters 307a-307f may include a first pair of rib-strip converters 307a, 307b connecting the input beam splitter 306 to the pair of intermediate waveguides 308, 310, such that a first rib-strip converter 307a of the pair connects the input beam splitter 306 to the first intermediate waveguide 308 and a second rib-strip converter 307b of the pair connects the input beam splitter 306 to the second intermediate waveguide 310. Similarly, the set of rib-strip converters 307a-307f may include a second pair of rib-strip converters 307c, 307d connecting the pair of intermediate waveguides 308, 310 to the output beam splitter 312, such that a first rib-strip converter 307c of the pair connects the first intermediate waveguide 308 to the output beam splitter 312 and a second rib-strip converter 307d of the pair connects the second intermediate waveguide 310 to the output beam splitter 312.

In the variation shown in FIG. 3, each input waveguide of the set of input waveguides (e.g., input waveguide 304) is configured as a rib waveguide as it reaches the input beam splitter 306. In other variations, one or more input waveguides of the set of input waveguides (e.g., the first input waveguide 304) may be configured as a strip waveguide, in which instance the set of rib-strip converters 307a-307f may include one or more additional rib-strip converters (not shown) positioned between these input waveguides and the input beam splitter 306. Additionally, in some variations it may be desirable for the output waveguide 314 to have a strip section 318a that is configured as a strip waveguide and a rib section 318b that is configured as a rib waveguide. In these variations, the set of rib-strip converters 307a-307f may also include a third pair of rib-strip converters 307e, 307f, where a first rib-strip converter 307e of the pair connects the output beam splitter 312 to the strip section 318a of the output waveguide 314 and a second rib-strip converter 307f of the pair connects the strip section 318a to the rib section 318b.

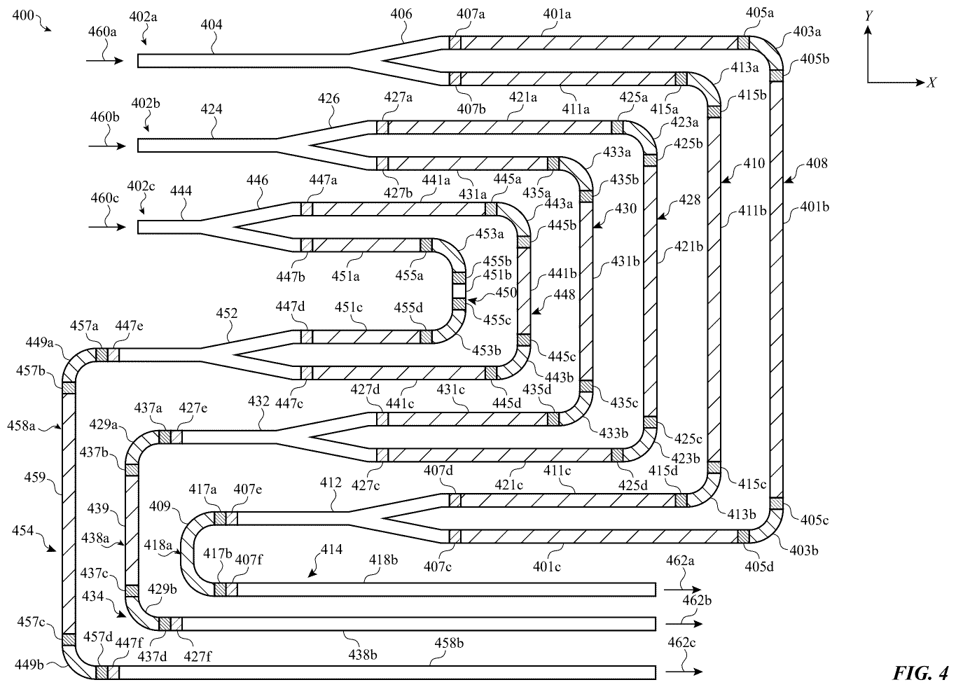

In variations in which the output waveguide 314 includes a strip section 318a, the strip section 318a may include a set of bends (shown in FIG. 3 as a single bend 309) that is configured to change a direction of the output waveguide 314. In some variations, the strip section 318a may include a plurality of bends and/or a set of straight segments, such as described herein with respect to FIG. 4. The MZI 302 may further include a third set of tapers 317a-317b that may change the width of the strip section 318a to account for a narrower width of the set of bends (e.g., bend 309) as compared to other segments of the output waveguide 314. Accordingly, light may exit the output beam splitter 312 along a second direction, which may facilitate a small form factor of the MZI 302 as described herein, but the set of bends allows the output waveguide 314 to route the output signal 362 in another direction. For example, in the variation shown in FIG. 3, the bend 309 is configured as a 180-degree bend, such that at least a portion of the rib section 318b of the output waveguide carries the output signal 362 along the first direction.

The configuration of the MZI 302 of FIG. 3 may allow for multiple MZIs to be nested together with a compact form factor. FIG. 4 shows a variation of a photonic integrated circuit 400 that includes a nested plurality of MZIs 402a-402c. While the nested plurality of MZIs 402a-402c is shown in FIG. 4 as having three MZIs (e.g., a first MZI 402a, a second MZI 402b, and a third MZI 402c), it should be appreciated that the nested plurality of MZIs 402a-402c may alternatively include two or four or more MZIs if so desired.

The nested plurality of MZIs 402a-402c may be incorporated into the wavelength locking unit 202 of FIG. 2 in place of the MZIs 208a-208c. In these variations, the nested plurality of MZIs 402a-402c generates a plurality of output signals 462a-462c that is measured by the detector 212 and used by the controller 214 to control the operation of light source 204, such as described herein with respect to FIG. 2. Specifically, the first MZI 402a is configured to i) receive a first input light 460a that is a first portion of the measured light generated by the light source 204, and ii) output a first output signal 462a of the plurality of output signals 462a-462c that may be measured by a first detector element 212a of the wavelength locking unit 202. The second MZI 402b is configured to i) receive a second input light 460b that is a second portion of the measured light generated by the light source 204, and ii) output a second output signal 462b of the plurality of output signals 462a-462c that may be measured by a second detector element 212b of the wavelength locking unit 202. The third MZI 402c is configured to i) receive a third input light 460c that is a first third portion of the measured light generated by the light source 204, and ii) output a third output signal 462c of the plurality of output signals 462a-462c that may be measured by a third detector clement 212c of the wavelength locking unit 202. The nested plurality of MZIs 402a-402c may be configured such that the plurality of output signals 462a-462c have different intensity-wavelength relationships. For example, the first, second, and third pairs of intermediate waveguides may be configured to provide different phase delays for a given wavelength of light passing through these pairs of intermediate waveguides.

Each of the nested plurality of MZIs 402a-402c may be configured in any manner as described herein with respect to the MZI 302 of FIG. 3. Specifically, each of the nested plurality of MZIs 402a-402c includes a corresponding set of input waveguides, a corresponding pair of intermediate waveguides, a corresponding set of output waveguides, a corresponding input beam splitter connecting the corresponding set of input waveguides to the corresponding pair of intermediate waveguides in a corresponding first direction, and a corresponding output beam splitter connecting the corresponding pair of intermediate waveguides to the corresponding set of output waveguides in a corresponding second direction different than the corresponding first direction.

For example, the first MZI 402a includes a first set of input waveguides (shown in FIG. 4 as a single input waveguide 404), a first pair of intermediate waveguides 408, 410 that includes a first intermediate waveguide 408 and a second intermediate waveguide 410, a first set of output waveguides (shown in FIG. 4 as a single output waveguide 414), a first input beam splitter 406 connecting the first set of input waveguides to the first pair of intermediate waveguides 408, 410, and a first output beam splitter 412 connecting the first pair of intermediate waveguides 408, 410 to the first set of output waveguides. The second MZI 402b includes a second set of input waveguides (shown in FIG. 4 as a single input waveguide 424), a second pair of intermediate waveguides 428, 430 that includes a first intermediate waveguide 428 and a second intermediate waveguide 430, a second set of output waveguides (shown in FIG. 4 as a single output waveguide 434), a second input beam splitter 426 connecting the second set of input waveguides to the second pair of intermediate waveguides 428, 430, and a second output beam splitter 432 connecting the second pair of intermediate waveguides 428, 430 to the second set of output waveguides. The third MZI 402c includes a third set of input waveguides (shown in FIG. 4 as a single input waveguide 444), a third pair of intermediate waveguides 448, 450 that includes a first intermediate waveguide 448 and a second intermediate waveguide 450, a third set of output waveguides (shown in FIG. 4 as a single output waveguide 454), a third input beam splitter 446 connecting the third set of input waveguides to the third pair of intermediate waveguides 448, 450, and a third output beam splitter 452 connecting the third pair of intermediate waveguides 448, 450 to the third set of output waveguides.

In some variations, each of the input beam splitters 406, 426, 446 are configured to connect the corresponding set of input waveguides to the corresponding pair of intermediate waveguides along a first common direction. In these instances, light may enter each of the first pair of intermediate waveguides 408, 410, the second pair of intermediate waveguides 428, 430, and the third pair of intermediate waveguides 448, 450 along the first common direction. Similarly, each of the output beam splitters 412, 432, 452 may be configured to connect the corresponding pair of intermediate waveguides to the corresponding set of output waveguides along a second common direction that is different than the first common direction. In these instances, light may exit each of the first pair of intermediate waveguides 408, 410, the second pair of intermediate waveguides 428, 430, and the third pair of intermediate waveguides 448, 450 along the second common direction. In some of these variations, the first common direction is opposite the second common direction.

Accordingly, the corresponding pair of intermediate waveguides of each of the nested plurality of MZIs 402a-402c may be configured to redirect light traveling between the corresponding input beam splitter and the corresponding output beam splitter. Specifically, each corresponding pair of intermediate waveguides is configured to wind in a common winding direction (e.g., a clockwise direction as shown in FIG. 4) between the corresponding input beam splitter and the corresponding output beam splitter. For example, each intermediate waveguide of the first pair of intermediate waveguide 408, 410 winds in a common direction between the first input beam splitter 406 and the first output beam splitter 412, each intermediate waveguide of the second pair of intermediate waveguide 428, 430 winds in the common direction between the second input beam splitter 426 and the second output beam splitter 432, and each intermediate waveguide of the third pair of intermediate waveguide 448, 450 winds in the common direction between the third input beam splitter 446 and the third output beam splitter 452.

The corresponding pair of intermediate waveguides of each of the nested plurality of MZIs 402a-402c may include a corresponding set of bends and a corresponding set of straight segments. In the variation shown in FIG. 4, the first intermediate waveguide 408 of the first MZI 402a includes i) a first set of straight segments 401a-401c that includes a first straight segment 401a, a second straight segment 401b, and a third straight segment 401c, and ii) a first set of bends 403a-403b that includes a first bend 403a connecting the first straight segment 401a to the second straight segment 401b and a second bend 403b connecting the second straight segment 401b to the third straight segment 401c. Similarly, the second intermediate waveguide 410 of the first MZI 402a includes i) a second set of straight segments 411a-411c that includes a first straight segment 411a, a second straight segment 411b, and a third straight segment 411c, and ii) a second set of bends 413a-413b that includes a first bend 413a connecting the first straight segment 411a to the second straight segment 411b and a second bend 413b connecting the second straight segment 411b to the third straight segment 411c.

The first intermediate waveguide 428 of the second MZI 402b includes i) a first set of straight segments 421a-421c that includes a first straight segment 421a, a second straight segment 421b, and a third straight segment 421c, and ii) a first set of bends 423a-423b that includes a first bend 423a connecting the first straight segment 421a to the second straight segment 421b and a second bend 423b connecting the second straight segment 421b to the third straight segment 421c. Similarly, the second intermediate waveguide 430 of the second MZI 402b includes i) a second set of straight segments 431a-431c that includes a first straight segment 431a, a second straight segment 431b, and a third straight segment 431c, and ii) a second set of bends 433a-433b that includes a first bend 433a connecting the first straight segment 431a to the second straight segment 431b and a second bend 433b connecting the second straight segment 431b to the third straight segment 431c.

The first intermediate waveguide 448 of the third MZI 402c includes i) a first set of straight segments 441a-441c that includes a first straight segment 441a, a second straight segment 441b, and a third straight segment 441c, and ii) a first set of bends 443a-443b that includes a first bend 443a connecting the first straight segment 441a to the second straight segment 441b and a second bend 443b connecting the second straight segment 441b to the third straight segment 441c. Similarly, the second intermediate waveguide 450 of the third MZI 402c includes i) a second set of straight segments 451a-451c that includes a first straight segment 451a, a second straight segment 451b, and a third straight segment 451c, and ii) a second set of bends 453a-453b that includes a first bend 453a connecting the first straight segment 451a to the second straight segment 451b and a second bend 453b connecting the second straight segment 451b to the third straight segment 451c.

In some variations, certain segments of the corresponding pair of intermediate waveguides for one MZI of the nested plurality of MZIs 402a-402c may be parallel to corresponding segments of the corresponding pair of intermediate waveguides of another MZI of the nested plurality of MZIs 402a-402c. For example, the first straight segments 401a, 411a of the first pair of intermediate waveguides 408, 410 may be parallel to the first straight segments 421a, 431a of the second pair of intermediate waveguides 428, 430 and may also be parallel to the first straight segments 441a, 451a of the third pair of intermediate waveguides 448, 450. Similarly, the second straight segments 401b, 411b of the first pair of intermediate waveguides 408, 410 may be parallel to the second straight segments 421b, 431b of the second pair of intermediate waveguides 428, 430 and may also be parallel to the second straight segments 441b, 451b of the third pair of intermediate waveguides 448, 450. The third straight segments 401c, 411c of the first pair of intermediate waveguides 408, 410 may be parallel to the third straight segments 421c, 431c of the second pair of intermediate waveguides 428, 430 and may also be parallel to the third straight segments 441c, 451c of the third pair of intermediate waveguides 448, 450. The first straight segments of each pair of intermediate waveguides may also, in some variations, be parallel to the third straight segments of each pair of intermediate waveguides.

In some variations, each MZI of the nested plurality of MZIs 402a-402c may be configured such that each of the corresponding first set of bends has a common configuration as a corresponding bend of the second set of bends for that MZI, such as described herein with respect to the bends 303a-303b, 313a-313b of FIG. 3. In some variations, multiple MZIs of the nested plurality of MZIs 402a-402c may have bends with common configurations. For example, in the variation shown in FIG. 4, the first bends 403a, 413a of the first pair of intermediate waveguides 408, 410 may have a first common configuration. The first bends 423a, 433a of the second pair of intermediate waveguides 428, 430 and the first bends 443a, 453a of the third pair of intermediate waveguides 448, 450 may also have the first common configuration. Similarly, the seconds bends 403b, 413b of the first pair of intermediate waveguides 408, 410 may have a second common configuration. The second bends 423b, 433b of the second pair of intermediate waveguides 428, 430 and the second bends 443b, 453b of the third pair of intermediate waveguides 448, 450 may also have the second common configuration. In some of these variations, the first common configuration may be the same as the second common configuration, such that all of the bends of the corresponding pairs of intermediate waveguides of the nested plurality of MZIs 402a-402c have a common configuration.

It should be appreciated that each corresponding pair of intermediate waveguides of the nested plurality of MZIs 402a-402c may be configured such that the corresponding straight segments are wider than the corresponding bends. In these variations, each corresponding pair intermediate waveguides may include one or more sets of tapers to change the width of the intermediate waveguides between corresponding straight segments and bends. It should be appreciated that although the various segments of the waveguides are shown in FIG. 4 as having the same width and different cross-hatching for case of illustration, these various segments may have any widths such as described and illustrated herein with respect to the MZI 302 of FIG. 3.

For example, in some variations the first set of straight segments 401a-401c and the second set of straight segments 471a-411c of the first pair of intermediate waveguides 408, 410 each have a common first width, and the first set of bends 403a-403b and the second set of bends 413a-413b of the first pair of intermediate waveguides 408, 410 each have a common second width that is narrower than the first width. The first intermediate waveguide 408 may include a first set of tapers 405a-405d and the second intermediate waveguide 410 includes a second set of tapers 415a-415d such as discussed in more detail with regard to the MZI 302 of FIG. 3.

The first set of straight segments 421a-421c and the second set of straight segments 431a-431c of the second pair of intermediate waveguides 428, 430 may also each have the first width, and the first set of bends 423a-423b and the second set of bends 433a-433b of the second pair of intermediate waveguides 428, 430 may each have the second width. The first intermediate waveguide 428 may include a first set of tapers 425a-425d and the second intermediate waveguide 430 includes a second set of tapers 435a-435d such as discussed in more detail with regard to the MZI 302 of FIG. 3. Similarly, the first set of straight segments 441a-441c and the second set of straight segments 451a-451c of the third pair of intermediate waveguides 448, 450 may also each have the first width, and the first set of bends 443a-443b and the second set of bends 453a-453b of the second pair of intermediate waveguides 448, 450 may each have the second width. The first intermediate waveguide 448 may include a first set of tapers 445a-445d and the second intermediate waveguide 430 includes a second set of tapers 455a-455d such as discussed in more detail with regard to the MZI 302 of FIG. 3.

In some variations, it may be desirable to configure certain portions of the nested plurality of MZIs 402a-402c from rib waveguides and other portions of the nested plurality of MZIs 402a-402c from strip waveguides. In the variation shown in FIG. 4, each MZI of the nested plurality of MZIs 402a-402c is configured such that each waveguide of its corresponding pair of intermediate waveguides 308, 310 is configured as a strip waveguide and the corresponding input beam splitter and output beam splitter are each formed using rib waveguides. In these variations, each MZI of the nested plurality of MZIs 402a-402c may include a corresponding first pair of rib-strip converters connecting the corresponding input beam splitter to the corresponding pair of intermediate waveguides. Additionally, each MZI of the nested plurality of MZIs 402a-402c may include a corresponding second pair of rib-strip converters connecting the corresponding pair of intermediate waveguides to the corresponding output beam splitter.

For example, the first MZI 402a may include a first set of rib-strip converters 407a-407f, that includes a first pair 407a, 407b connecting the first input beam splitter 406 to the first pair of intermediate waveguides 408, 410 and a second pair 407c, 407d connecting the first pair of intermediate waveguides 408, 410 to the first output beam splitter 412. The second MZI 402b may include a second set of rib-strip converters 427a-427f, that includes a first pair 427a, 427b connecting the second input beam splitter 426 to the second pair of intermediate waveguides 428, 430 and a second pair 427c, 427d connecting the second pair of intermediate waveguides 428, 430 to the second output beam splitter 432. Similarly, the third MZI 402b may include a third set of rib-strip converters 447a-447f, that includes a first pair 447a, 447b connecting the third input beam splitter 446 to the third pair of intermediate waveguides 448, 450 and a second pair 447c, 447d connecting the third pair of intermediate waveguides 448, 450 to the third output beam splitter 452. In the variation shown in FIG. 4, each of the input beam splitters 406, 426, 446 and the output beam splitters 412, 432, 452 is configured as a rib waveguide y-branch splitter.

In the variation shown in FIG. 4, each output waveguide of the corresponding set of output waveguides for each MZI of the nested plurality of MZIs 402a-402c may include a corresponding strip section that is configured as a strip waveguide and a corresponding rib section that is configured as a rib waveguide. In these instances, the corresponding strip section connects the corresponding output beam splitter to the corresponding rib section. Each strip section may include a set of bends configured to change a direction of the corresponding output waveguide and may additionally include one or more straight segments.

For example, the output waveguide 414 of the first set of output waveguides may include a first strip portion 418a and a first rib portion 418b. In these variations, the first set of rib-strip converters 407a-407f may also include a third pair of rib-strip converters 407e, 407f, where a first rib-strip converter 407e of the pair connects the first output beam splitter 412 to the first strip section 418a of the output waveguide 414 and a second rib-strip converter 407f of the pair connects the first strip section 418a to the first rib section 418b. The first strip portion 418a include a set of bends (shown in FIG. 4 as a single bend 409) that is configured to change to change a direction of the output waveguide 414. In some variations, the first strip section 418a may include one or more additional bends and/or a set of straight segments. The first strip section 418a may also include a plurality of tapers 417a-417b such as described herein with respect to the MZI 302 of FIG. 3.

Similarly, the output waveguide 434 of the second set of output waveguides may include a second strip portion 438a and a second rib portion 438b. In these variations, the second set of rib-strip converters 427a-427f may also include a third pair of rib-strip converters 427e, 427f, where a first rib-strip converter 427e of the pair connects the second output beam splitter 432 to the second strip section 438a of the output waveguide 434 and a second rib-strip converter 427f of the pair connects the second strip section 438a to the second rib section 438b. The second strip portion 438a include a set of bends 429a-429b and a set of straight segments (shown in FIG. 4 as a single first straight segment 439). For example, in the variation shown in FIG. 4, the second strip portion 438a includes the first straight segment 439 positioned between a first bend 429a and a second bend 429b. The set of bends 429a-429b may have a different width than set of straight segments 439, and thus the second strip section 438a may include a plurality of tapers 437a-437d, such as described herein. For example, a first taper 437a may connect the rib-strip converter 427e (and thereby the second output beam splitter 432) to the first bend 429a, a second taper 437b may connect the first bend 429a to the first straight segment 439, a third taper 437c may connect the first straight segment 439 to the second bend 429b, and a fourth taper 437d may connect the second bend 429b to the rib-strip converter 427f (and thereby the second rib portion 438b).

The output waveguide 454 of the third set of output waveguides may include a third strip portion 458a and a third rib portion 458b. In these variations, the third set of rib-strip converters 447a-447f may also include a third pair of rib-strip converters 447e, 447f, where a first rib-strip converter 447e of the pair connects the third output beam splitter 452 to the third strip section 458a of the output waveguide 454 and a second rib-strip converter 447f of the pair connects the third strip section 458a to the third rib section 458b. The third strip portion 458a include a set of bends 449a-449b and a set of straight segments (shown in FIG. 4 as a single first straight segment 459). For example, in the variation shown in FIG. 4, the third strip portion 458a includes the first straight segment 459 positioned between a first bend 449a and a second bend 449b. The set of bends 449a-449b may have a different width than set of straight segments 459, and thus the third strip section 458a may include a plurality of tapers 457a-457d, such as described herein. For example, a first taper 457a may connect the rib-strip converter 447e (and thereby the third output beam splitter 452) to the first bend 449a, a second taper 457b may connect the first bend 449a to the first straight segment 459, a third taper 457c may connect the first straight segment 459 to the second bend 449b, and a fourth taper 457d may connect the second bend 449b to the rib-strip converter 447f (and thereby the third rib portion 458b).

In some variations, the corresponding sets of bends of the first, second, and third strip portions 418a, 438a, 458a may be configured to redirect the respective output waveguides 414, 434, 454 such that at least a portion of the first, second and third rib portions 418b, 438b, 458b are parallel. In these instances, the output signals 462a-462c generated by the nested plurality of MZIs 402a-402c may be routed in a common direction (e.g., toward the detector elements 212a-212c of the wavelength locking unit 202 of FIG. 2).

Within the nested plurality of MZIs 402a-402c, the corresponding pair of output waveguides of one MZI may at least partially wrap around one or more additional MZIs. For example, in the variation shown in FIG. 4, the nested plurality of MZIs 402a-402c are configured such that a first portion of the second MZI 402b is positioned between the first input beam splitter 406 and the first output beam splitter 412 (e.g. along the Y-axis shown in FIG. 4). The first pair of intermediate waveguides 408, 410 at least partially wrap around the second pair of intermediate waveguides 428, 430 to allow the second MZI 402b to be at least partially positioned between the first input beam splitter 406 and the first output beam splitter 412. For example, the corresponding second straight segments 401b, 411b of the first pair of intermediate waveguides 408, 410 may be longer than each of the corresponding straight segments 421b, 431b of the second pair of intermediate waveguides 428, 430.

Similarly, the nested plurality of MZIs 402a-402c are configured such that a first portion of the third MZI 402c is positioned between the second input beam splitter 426 and the second output beam splitter 432 (e.g. along the Y-axis shown in FIG. 4). The second pair of intermediate waveguides 428, 430 at least partially wrap around the third pair of intermediate waveguides 448, 450 to allow the third MZI 402c to be at least partially positioned between the second input beam splitter 426 and the second output beam splitter 432. For example, the corresponding straight segments 421b, 431b of the second pair of intermediate waveguides 428, 430 may be longer than each of the corresponding straight segments 441b, 451b of the third pair of intermediate waveguides 448, 450.

Accordingly, by wrapping part of the first MZI 402a around the second MZI 402b, and by wrapping part of the second MZI 402b around the third MZI 402c, the nested plurality of MZIs 402a-402c may reduce wasted space and have a relatively compact footprint. This may reduce the susceptibility of the nested plurality of MZIs 402a-402c to localized temperature variations in the photonic integrated circuit 400.

Additionally, in some variations the nested plurality of MZIs 402a-402c is configured such that the output waveguide of one MZI at least partially wraps around one or more additional MZIs. For example, in the variation shown in FIG. 4, the nested plurality of MZIs 402a-402c is configured such that a first portion of the first MZI 402a is positioned between the second output beam splitter 426 and the second set of output waveguides. For example, the first rib portion 418b of the waveguide 414 of the first MZI 402a may be positioned between the second rib portion 438b of the waveguide 434 of the second MZI 402a and the second output beam splitter 426. In these instances, the second strip portion 438a of the waveguide 434 may at least partially wrap around the first strip portion 418a of the waveguide 414.

Similarly, the nested plurality of MZIs 402a-402c may also be configured such that a second portion of the second MZI 402b is positioned between the third output beam splitter 446 and the third set of output waveguides. For example, the second rib portion 438b of the waveguide 434 of the second MZI 402a may be positioned between the third rib portion 458b of the waveguide 454 of the third MZI 402c and the third output beam splitter 446. In these instances, the third strip portion 458b of the waveguide 454 may at least partially wrap around the second strip portion 438a of the waveguide 434. For example, the first straight segment 459 of the third strip portion 458a may be longer than the first straight segment 439 of the second strip portion 438a.

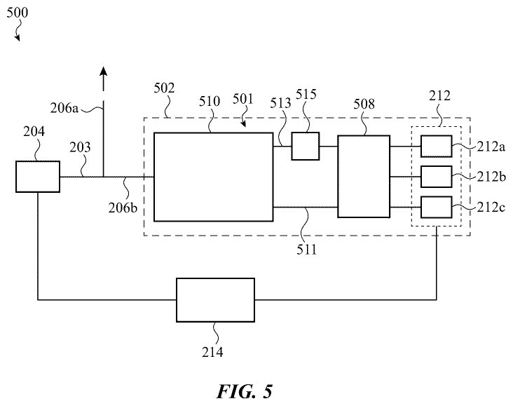

Other embodiments described herein include an interferometric arrangement with a splitter, a coupler, and a pair of intermediate waveguides connecting the splitter to the coupler. For example, FIG. 5 shows a variation of a photonic integrated circuit 500 as described herein. The photonic integrated circuit 500 may be configured and labeled the same as the photonic integrated circuit 200 of FIG. 2 (e.g., including light source 204, waveguide 203, first output 206a, second output 206b, and controller 214), except that the wavelength locking unit 202 has been replaced with wavelength locking unit 502. The wavelength locking unit 502 includes an interferometric arrangement 501 and the detector 212 of FIG. 2 that includes a corresponding set of detector elements 212a-212c. The wavelength locking unit 502 may be utilized to control the operation of the light source 204 as described herein with respect to FIG. 2 (e.g., to control a wavelength of light generated by the light source 204 to a target wavelength).

The interferometric arrangement 501 includes a coupler 508, a splitter 510, and a pair of intermediate waveguides (including a first intermediate waveguide 511 and a second intermediate waveguide 513) that connect the splitter 510 to the coupler 508. Specifically, the splitter 510 includes a splitter input, a first splitter output and a second splitter output, and is configured to split light received by the splitter input between the first splitter output and the second splitter output. The splitter 510 may receive, at the splitter input, input light that is generated by the light source 204 (e.g., a portion of the light generated by the light source 204 via the second output 206b). First intermediate waveguide 511 may be connected to the first splitter input, the second intermediate waveguide 513 may be connected to the second splitter input, and the splitter 510 may split the input light into a first split portion that is passed to the first intermediate waveguide 511 (e.g., via the first splitter output) and a second split portion that is passed to the second intermediate waveguide 513 (e.g., via the second splitter output).

The coupler 508 is configured to receive the first split portion and the second split portion of the input light and generate a plurality of output signals. Specifically, the coupler 508 includes a first coupler input connected to the first intermediate waveguide 511, a second coupler input connected to the second intermediate waveguide 513, and a plurality of coupler outputs. The plurality of coupler outputs, in turn, are connected to a plurality of output waveguides. Each output waveguide is optically connected to a corresponding detector element of the detector 212 (e.g., to a corresponding detector element of the set of detector elements 212a-212c). In this way, the output signals generated by the coupler 508 may be routed to the detector elements 212a-212c via the plurality of output waveguides.

The interferometric arrangement 501 is configured such that the second intermediate waveguide 513 introduces a phase delay (schematically represented in FIG. 5 by box 515) relative to first intermediate waveguide 511. In this way, light carried by the first intermediate waveguide 511 (e.g., the first split portion of the input light) and the second intermediate waveguide 513 (e.g., the second split portion of the input light) may be phase shifted upon reaching the coupler 508. This phase delay 515 is generated at least in part based on length differential between the first intermediate waveguide 511 and the second intermediate waveguide 513 (e.g., the second intermediate waveguide 513 is longer than the first intermediate wavelength 511 such that light travels a relatively longer distance between the splitter 510 and the coupler 508 along the second intermediate waveguide 513). It should be appreciated that, in some variations, one or more of the first intermediate waveguide 511 or the second intermediate waveguide 513 may include a corresponding set of phase shifter(s) that may be used to controllably adjust the phase delay 515 between the first intermediate waveguide 511 and the second intermediate waveguide 513.

The coupler 508 is configured to, upon receiving the first split portion of the input light (e.g., at the first coupler input via the first intermediate waveguide 511) and the second split portion of the input light (e.g., at the second coupler input via the second intermediate waveguide 513), generate the plurality of output signals. Specifically, each output signal has a corresponding intensity that is based on interference between the first split portion and the second split portion of the input light. The relative intensities of the plurality of output signals depends at least in part on the phase difference between the split portions of the input light (e.g., as provided by the phase delay 515 between the first intermediate waveguide 511 and the second intermediate waveguide 513), which in turn depends at least in part on the wavelength of the input light. The coupler 508 may be configured such that the output signals each have a different intensity-wavelength relationship, such as described herein with respect to the photonic integrated circuit 200 of FIG. 2. Similarly, the output signals generated by the coupler 508 may be measured by detector 212, and may be used by the controller 214 to control operation of the light source 204 (e.g., such that the light emitted by light source 204, when measured at a particular location in the photonic integrated circuit 500, has a target wavelength). It should be appreciated that the wavelength locking unit 502 may be used to control a plurality of light sources as described in more detail herein.

In the variation shown in FIG. 5, the coupler 508 is a two-by-three coupler that includes a first coupler input, a second coupler input, and a plurality of coupler outputs that includes a first coupler output, a second coupler output, and a third coupler output. In these variations, the coupler 508 is configured to generate a corresponding plurality of output signals that includes a first output signal, a second output signal, and a third output signal. For example, the first coupler output may generate a first output signal having a first intensity-wavelength relationship, the second first coupler output may generate a second output signal having a second intensity-wavelength relationship that is phase-shifted relative to the first intensity-wavelength relationship, and the third coupler output may generate a third output signal having a third intensity-wavelength relationship that is phase-shifted relative to each of the first intensity-wavelength relationship and the second intensity-wavelength relationship. In these instances, the corresponding intensity-wavelength relationships of the first, second, and third output signals will have local maximums at different wavelengths. For any given target wavelength, at least one of the output signals will be at or near a local maximum. Accordingly, in analyzing the measured output signals, the controller 214 may prioritize output signals that are closer to local maximums of their corresponding intensity-wavelength relationships. It should be appreciated that the coupler 508 may be configured to have a different number of outputs (e.g., four or more outputs) and generate corresponding plurality of outputs if so desired.

In the schematic diagram of FIG. 2, the first and second intermediate waveguides 511, 513 of the interferometric arrangement 501 are shown positioned in a side-by-side arrangement between the coupler 508 and the splitter 510. In these instances, localized temperature variations (such as a temperature gradients) within the photonic integrated circuit 200 may differentially impact the first and second intermediate waveguides 511, 513, and thereby impact the phase delay 515 provided by these waveguides. These changes to the phase delay 515 may also cause fluctuations in the phase of intensity-wavelength relationship of the output signal generated by coupler 508. This may cause the controller 214 to erroneously interpret these temperature-induced changes to the plurality of output signals as a change in wavelength emitted by the light source 204, which may limit the accuracy of the wavelength locking unit 502 in controlling the operation of the light source 204.

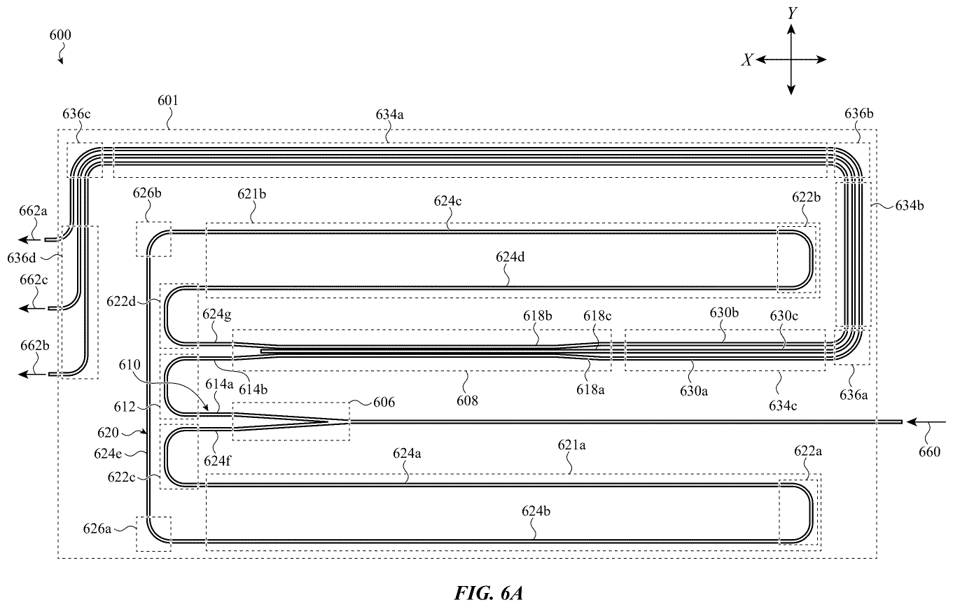

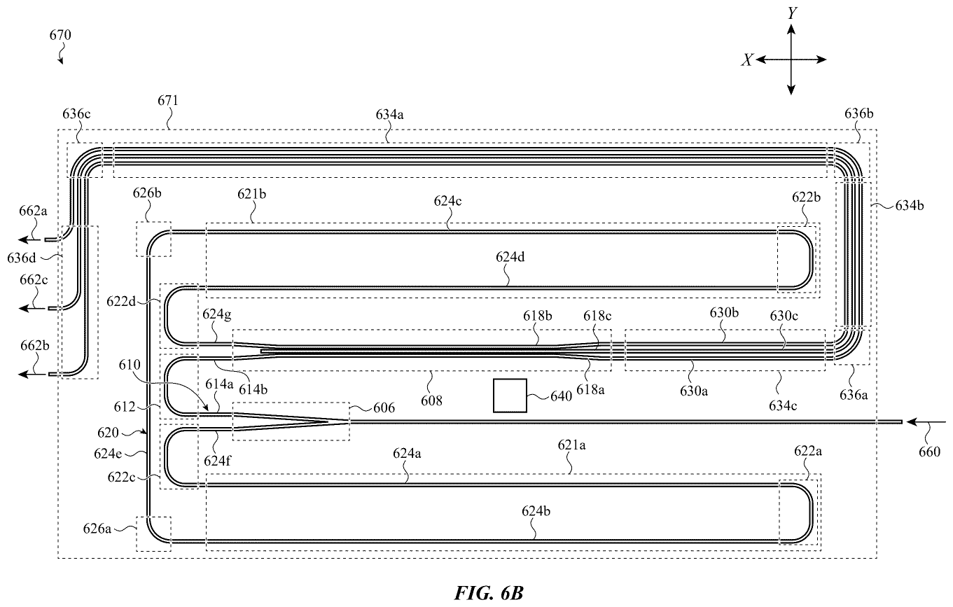

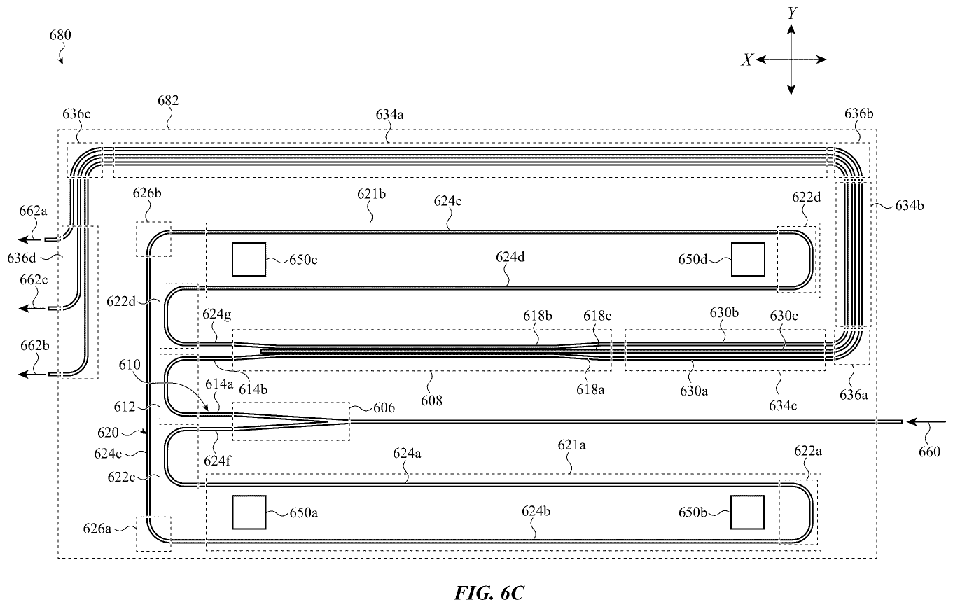

To help reduce the impact of these gradients, the interferometric arrangement 501 may be configured such that some of the components of the interferometric arrangement 501 are nested within the second intermediate waveguide 513. For example, FIG. 6A shows a top view of a photonic integrated circuit 600 that includes a nested interferometric arrangement 601. The interferometric arrangement 601 may be incorporated into the wavelength locking unit 502 (e.g., in place of the interferometric arrangement 501) to generate a plurality of output signals.

Specifically, the interferometric arrangement 601 includes an input waveguide 604, a splitter 606, a coupler 608, and a pair of intermediate waveguides (including a first intermediate waveguide 610 and a second intermediate waveguide 620) connecting the splitter 606 to the coupler 608, and a plurality of output waveguides 630a-630c connected to the coupler 608. The interferometric arrangement 601 is configured to receiving input light 660 along the input waveguide 604, and is configured to generate, using the input light 660, a plurality of output signals 662a-662c. The plurality of output signals 662a-662c may be carried to and measured by the detector 212 using the plurality of output waveguides 630a-630c. Accordingly, the plurality of output signals 662a-662c may be used by the controller 214 to control the operation of light source 204, such as described herein with respect to FIG. 5.

The splitter 606 includes a splitter input connected to the input waveguide 604, a first splitter output connected to the first intermediate waveguide 610, and a second splitter output connected to the second intermediate waveguide 620. The splitter 606 is configured such that input light 660 received by the input waveguide 604 will be split between the first intermediate waveguide 610 and the second intermediate waveguide 620. In this way, the first intermediate waveguide 610 may receive a first split portion of the input light 660 and the second intermediate waveguide 620 may receive a second split portion of the input light 660. The splitter 606 may be configured as any suitable beam splitting component such as a y branch splitter, directional coupler, multimode interferometer, or the like.

The coupler 608 includes a first coupler input connected to the first intermediate waveguide 610, a second coupler input connected to the second intermediate waveguide 620, and a plurality of coupler outputs connected to the plurality of output waveguides 630a-630c. In the variation shown in FIG. 6A, the coupler 608 is configured as a two-by-three coupler having two coupler inputs and three coupler outputs. Specifically, the coupler 608 may, when configured as a two-by-three coupler, have a first coupler output connected to a first output waveguide 630a of the plurality of output waveguides 630a-630c, a second coupler output connected to a second output waveguide 630b of the plurality of output waveguides 630a-630c, and a third coupler output connected to a third output waveguide 630c of the plurality of output waveguides 630a-630c. In these instances, the coupler 608 may, upon receiving the first and seconds split portions of the input light 660, generate a first output signal 662a of the plurality of output signals 662a-662c at the first coupler output, a second output signal 662b of the plurality of output signals 662a-662c at the second coupler output, and a third output signal 662c of the plurality of output signals 662a-662c at the third coupler output.

The coupler 608 may be configured in any suitable manner, such as those described in U.S. Pat. No. 12,321,014, filed on May 27, 2022, and titled “Coupling Devices and Methods, Wavelength Locking Systems and Methods, and Phase Unwrapping Systems and Methods”, the contents of which are hereby incorporated by reference in their entirety. For example, in the variation shown in FIG. 6A, the coupler 608 may include three coupler waveguides 618a-618c. Specifically, the coupler 608 may include a first coupler waveguide 618a that connects the first coupler input to the first coupler output (and thereby connects the first intermediate waveguide 610 to the first output waveguide 630a) and a second coupler waveguide 618b that connects the second coupler input to the second coupler output (and thereby connects the second intermediate waveguide 620 to the second output waveguide 630b). The coupler 608 further includes a third coupler waveguide 618c that is positioned between the first coupler waveguide 618a and the second coupler waveguide 618b and is optically coupled to each of the first coupler waveguide 618a and the second coupler waveguide 618b along at least a portion of the coupler 608.

Specifically, a portion of the third coupler waveguide 618c is positioned close enough to the first coupler waveguide 618a such that light may couple from the third coupler waveguide 618c to the first coupler waveguide 618a and vice versa. Similarly, a portion of the third coupler waveguide 618c is positioned close enough to the second coupler waveguide 618b such that light may couple from the third coupler waveguide 618c to the second coupler waveguide 618b and vice versa. Accordingly, when the first coupler waveguide 618a receives the first split portion of the input light 660, some of this light may be coupled from the first coupler waveguide 618a to the third coupler waveguide 618c, and from there into the second coupler waveguide 618b. Similarly, when the second coupler waveguide 618b receives the second split portion of the input light 660, some of this light may be coupled from the second coupler waveguide 618b to the third coupler waveguide 618c, and from there into the first coupler waveguide 618a. As a result, each coupler waveguide of the coupler 608 may output a corresponding output signal that contains components of light received from both the first intermediate waveguide 610 and the second intermediate waveguide 620 (e.g., the first and second split portions of the input light 660). In this way, the coupler 608 may generate the plurality of output signals 662a-662c. It should be appreciated that the coupler 608 shown in FIG. 6A is an illustrative example, and that other variations of the interferometric arrangement 601 may replace coupler 608 with another two-by-three (or 2×N) coupler as may be desired. For example, in some variations the coupler 608 may be a 2×3 multimode interferometer or the like.

The first intermediate waveguide 610 connects the first splitter output to the first coupler input, thereby connecting the splitter 606 to the coupler 608. Similarly, the second intermediate waveguide 620 connects the second splitter output to the second coupler input, thereby connecting the splitter 606 to the coupler 608. The second intermediate waveguide 620 is configured to have a different length than the first intermediate waveguide 610, such that the first and second intermediate waveguides 610, 620 provide a phase delay between the first and second split portions of the input light 660.

In the variation of the first intermediate waveguide 610 shown in FIG. 6A, the first intermediate waveguide 610 includes a turn 612 that changes the direction of the first intermediate waveguide 610 between the splitter 606 and the coupler 608. The turn 612 may be defined by a single bend or a pair of bends that are separated by a straight segment of the first intermediate waveguide. In these variations, the first split portion of the input light 660 will exit the splitter 606 and enter the coupler 608 in opposite directions. For example, the first split portion of the input light 660 may exit the splitter 606 (e.g., via the first splitter output) into the first intermediate waveguide 610 along a first direction (e.g., from the right to the left along the X axis shown in FIG. 6A) and may enter the coupler 608 (e.g., via the first coupler input) from the first intermediate waveguide 610 along a second direction (e.g., from the left to the right along the X axis shown in FIG. 6) that is opposite the first direction.

In some variations, the first intermediate waveguide 610 may include one or more additional segments between the turn 612 and the splitter 606 and/or the coupler 608. For example, in the variation shown in FIG. 6A, the first intermediate waveguide 610 may include a first straight segment 614a connecting the splitter 606 to the turn 612 and a second straight segment 614b connecting the splitter 606 to the coupler 608.

The second intermediate waveguide 620 is configured such that it at least partially wraps around the coupler 608 and/or the splitter 606. For example, in the variation shown in FIG. 6A, the second intermediate waveguide 620 is configured such that the coupler 608 is positioned at least partially between a first portion 621a of the second intermediate waveguide 620 and a second portion 621b of the second intermediate waveguide 620 (e.g., along the Y axis shown in FIG. 6A). In some variations, the splitter is also positioned at least partially between the first portion 621a of the second intermediate waveguide 620 and the second portion 621b of the second intermediate waveguide 620 (e.g., along the Y axis shown in FIG. 6A).

To wrap the second intermediate waveguide 620 around the coupler 608 and splitter 606, the second intermediate waveguide 620 may include a plurality of straight segments 624a-624g, a plurality of bends 626a-626b, and a plurality of turns 622a-622d (each of which may include a single bend or a pair of bends connected by a straight segment). The first portion 621a of the second intermediate waveguide 620 includes a first straight segment 624a and a second straight segment 624b connected to each other by a first turn 622a. Similarly, the second portion 621b of the second intermediate waveguide 620 includes a third straight segment 624c and a fourth straight segment 624d connected to each other by a second turn 622b. In these variations, light may travel in opposite directions between the first straight segment 624a and the second straight segment 624b as well as between the third straight segment 624c and the fourth straight segment 624d.

The first and second portions 621a, 621b of the second intermediate waveguide 620 are connected to each other such that light received from the splitter 606 (e.g., the second split portion of the input light 660 from the second splitter output) passes through the first portion 621a before passing through the second portion 621b. For example, in the variation shown in FIG. 6, the second intermediate waveguide 620 includes a fifth straight segment 624e connecting the first portion 621a of the second intermediate waveguide 620 to the second portion 621b of the second intermediate waveguide 620. Specifically, a first bend 626a may connect the second straight segment 624b to the fifth straight segment 624e and a second bend 626b may connect the fifth straight segment 624e to the third straight segment 624c.

The second intermediate waveguide 620 may further include a third turn 622c connecting the first portion 621a of the second intermediate waveguide 620 (e.g., via the first straight segment 624a) to the splitter 606. In some of these variations, the second intermediate waveguide 620 further includes a sixth straight segment 624f connecting the third turn 622c to the splitter 606. Similarly, the second intermediate waveguide 620 may further include a fourth turn 622d connecting the second portion 621b of the second intermediate waveguide 620 (e.g., via the fourth straight segment 524d) to the coupler 608. In some of these variations, the second intermediate waveguide 620 further includes a seventh straight segment 624g connecting the fourth turn 622d to the coupler 608. Overall, light exiting the second splitter output (e.g., the second split portion of the input light 660) will pass sequentially through the sixth straight segment 624f (e.g., along the same first direction as the first spit portion of the input light 660), the third turn 622c, the first straight segment 624a (e.g., along the second direction opposite the first direction), the first turn 622a, the second straight segment 624b (e.g., along the first direction), the first bend 626a, the fifth straight segment 624e (e.g., along a third direction that may be perpendicular to each of the first and second directions), the second bend 626b, the third straight segment 624c (e.g. along the second direction), the second turn 622b, the fourth straight segment 624d (e.g., along the first direction), the fourth turn 622d, and the seventh straight segment 624g (e.g., along the second direction) before entering the second coupler input of the coupler 608. In this way, the second split portion of the input light 660 may exit the splitter 606 and enter the coupler 608 along opposite directions.

In some instances, the plurality of output waveguides 630a-630c may at least partially wrap around the second intermediate waveguide 620 (e.g., around the second portion 621b of the second intermediate waveguide 620). This may reduce the overall footprint of the interferometric arrangement 601. For example, the interferometric arrangement 601 may configured such that the second portion 621b of the second intermediate waveguide 620 is positioned at least partially between the coupler 608 and a first portion of the plurality of output waveguides 630a-630c. For example, the plurality of output waveguides 630a-630c may include a plurality of straight segments 634a-634c (in which each of the plurality of output waveguides 630a-630c has a corresponding straight segment) and a plurality of bends 636a-636d (in which each of the plurality of output waveguides 630a-630c has a corresponding straight segment). For example, the plurality of output waveguides 630a-630c may include a first straight segment 634a that is positioned such that the second portion 621b of the second intermediate waveguide 620 is positioned at least partially between the coupler 608 and the first straight segment 634a of the plurality of output waveguides 630a-630c. In this way, the second portion 621b of the second intermediate waveguide 620 may be positioned between the coupler 608 and a first portion of the first output waveguide 630a, may be positioned between the coupler 608 and a first portion of the second output waveguide 630b, and may be positioned between the coupler 608 and a first portion of the third output waveguide 630c.

In the variation shown in FIG. 6A, the plurality of output waveguides may include a first bend 636a that connects the coupler 608 to a second straight segment 634b, and a second bend 636b that connects the second straight segment 634b to the first straight segment 634a. In some variations, the plurality of output waveguides further includes a third straight segment 634c connecting the coupler 608 to the first bend 636a. Additionally or alternatively, the plurality of output waveguides may include a third bend 636c connected to the first straight segment 634a and a fourth bend 636d connected to the third bend 636c (e.g., directly or indirectly via one or more additional segment of the plurality of output waveguides). In variations where each of the first, second, third, and fourth bends 636a-636d are configured as 90-degree bends, the plurality of output waveguides may act to wrap around the second intermediate waveguide 620 such that light (e.g., the plurality of output signals 662a-662c) enters the first bend 636a and exits the fourth bend 636d in opposite directions.

In some variations, the second intermediate waveguide 620 is configured to be symmetric across an axis of symmetry. For example, in the variation shown in FIG. 6A, the second intermediate waveguide 620 is symmetric across an axis of symmetry that is parallel to the X axis shown in FIG. 6A. Additionally or alternatively, the first intermediate waveguide 610 may also be symmetric across an axis of symmetry. In some variations, the first intermediate waveguide 610 and the second intermediate waveguide 620 are symmetric across a common axis of symmetry (e.g., the first intermediate waveguide 610 and the second intermediate waveguide 620 are symmetric across the same line).

Configuring an interferometric arrangement as shown in FIG. 6A may help reduce the sensitivity of the interferometric arrangement to changes in phase delay (e.g., between the first intermediate waveguide 610 and the second intermediate waveguide 620) caused by temperature gradients. Additionally, in some variations a set of temperature sensors may be positioned and configured to measure corresponding temperatures at one or more locations of the interferometric arrangement 601. A controller (e.g., controller 214) may be configured to receive these temperature measurements and to take these measurements into account when controlling operation of a light source (e.g., light source 204). In this way, the controller may use this temperature information to correct for or otherwise identify changes to the plurality of output signals 662a-662c that may occur from temperature changes within the interferometric arrangement.

For example, FIG. 6B shows a variation of a photonic integrated circuit 670 that includes an interferometric arrangement 671. The photonic integrated circuit 670, as well as the interferometric arrangement 671, is configured and labeled the same as the corresponding components of FIG. 6A, except that the interferometric arrangement 671 includes a set of temperature sensors configured to measure temperature at a corresponding set of locations of the interferometric arrangement 671. While the set of temperature sensors is shown in FIG. 6B as having a single temperature sensor (e.g., temperature sensor 640), it should be appreciated that the interferometric arrangement may further include a plurality of temperature sensors (such as described herein with respect to FIG. 6B).

In the variation shown in FIG. 6B, the temperature sensor 640 is positioned to measure temperature at a location between the first portion 621a of the second intermediate waveguide 620 and the second portion 621b of the second intermediate waveguide 620. For example, in some variations the temperature sensor 640 is positioned to measure temperature at a location that is between the coupler 608 and the splitter 606 along a direction (e.g., along the Y axis shown in FIG. 6B). In instances where the second intermediate waveguide is symmetric along an axis of symmetry, the temperature sensor 640 may be positioned along the axis of symmetry. As the interferometric arrangement 671 is less sensitive to temperature gradients, measurements from the temperature sensor 640 may still be used to correct for temperature fluctuations without needed to characterize the nature of temperature gradients that may be present.

In addition to or as an alternative to the temperature sensor 640, an interferometric arrangement may include a plurality of temperature sensors. For example, FIG. 6C shows a variation of a photonic integrated circuit 680 that includes an interferometric arrangement 681. The photonic integrated circuit 680, as well as the interferometric arrangement 681, is configured and labeled the same as the corresponding components of FIG. 6A, except that the interferometric arrangement 681 includes a plurality of temperature sensors 650a-650d configured to measure temperature at a corresponding set of locations of the interferometric arrangement 681. By including a plurality of temperature sensors, a controller may characterize the nature of a temperature gradient (e.g., a direction and/or slope of a temperature gradient), which may allow for more comprehensive corrections in controlling the operation of a light source.

In the variation shown in FIG. 6C, the plurality of temperature sensors 650a-650d includes a first set of temperature sensors 650a-650b positioned to measure temperature a first set of locations between the first straight section 624a and the second straight section 624b of the second intermediate waveguide 620. While the first set of temperature sensors 650a-650b is shown in FIG. 6C as having two temperature sensors (e.g., a first temperature sensor 650a and a second temperature sensor 650d), in other variations the first set of temperature sensors may include a single sensor positioned to measure temperature between the first and second straight sections of the second intermediate waveguide. Additionally, the plurality of temperature sensors 650a-650d includes a second set of temperature sensors 650c-650d positioned to measure temperature a first set of locations between the third straight section 624c and the fourth straight section 624d of the second intermediate waveguide 620. While the second set of temperature sensors 650c-650d is shown in FIG. 6C as having two temperature sensors (e.g., a third temperature sensor 650c and a fourth temperature sensor 650c), in other variations the first set of temperature sensors may include a single sensor positioned to measure temperature between the third and fourth straight sections of the second intermediate waveguide.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

1. A photonic integrated circuit comprising:
a light source configured to generate light;
a wavelength locking unit configured to generate a plurality of output signals from a portion of the light; and
a controller configured to use the plurality of output signals to control the light source to generate the light at a target wavelength, wherein:
the wavelength locking unit comprises:
a nested plurality of Mach-Zehnder interferometers configured to generate the plurality of output signals, wherein each Mach-Zehnder interferometer of the nested plurality of Mach-Zehnder interferometers comprises:
a corresponding set of input waveguides;
a corresponding set of output waveguides;
a corresponding pair of intermediate waveguides;
a corresponding input beam splitter connecting the corresponding set of input waveguides to the corresponding pair of intermediate waveguides in a first common direction; and
a corresponding output beam splitter connecting the corresponding pair of intermediate waveguides to the corresponding set of output waveguides in a second common direction different than the first common direction; and
a plurality of detector elements configured to measure the plurality of output signals generated by the nested plurality of Mach-Zehnder interferometers.

2. The photonic integrated circuit of claim 1, wherein the first common direction is opposite the second common direction.

3. The photonic integrated circuit of claim 1, wherein each Mach-Zehnder interferometer of the nested plurality of Mach-Zehnder interferometers comprises:
a first pair of rib-strip converters connecting the corresponding input beam splitter to the corresponding pair of intermediate waveguides.

4. The photonic integrated circuit of claim 1, wherein each Mach-Zehnder interferometer of the nested plurality of Mach-Zehnder interferometers comprises:
a second pair of rib-strip converters connecting the corresponding pair of intermediate waveguides to the corresponding output beam splitter.

5. The photonic integrated circuit of claim 1, wherein the corresponding pair of intermediate waveguides for each Mach-Zehnder interferometer of the nested plurality of Mach-Zehnder interferometers comprises:
a corresponding first intermediate waveguide having a corresponding first set of straight segments and a corresponding first set of bends; and
a corresponding second intermediate waveguide having a corresponding second set of straight segments and a corresponding second set of bends.

6. The photonic integrated circuit of claim 5, wherein the corresponding first sets of bends and the corresponding second sets of bends of the nested plurality of Mach-Zehnder interferometers have a common configuration.

7. The photonic integrated circuit of claim 1, wherein the corresponding set of output waveguides of each Mach-Zehnder interferometer of the nested plurality of Mach-Zehnder interferometers comprises:
a corresponding first output waveguide having a corresponding rib portion and a corresponding strip portion that connects the corresponding rib portion to the corresponding output beam splitter.

8. The photonic integrated circuit of claim 7, wherein the corresponding rib portion of the corresponding first output waveguide of each Mach-Zehnder interferometer of the nested plurality of Mach-Zehnder interferometers comprises:
a corresponding set of bends.

9. A photonic integrated circuit comprising:
a light source configured to generate light;
a wavelength locking unit configured to generate a plurality output signals, the wavelength locking unit comprising:
a first Mach-Zehnder interferometer positioned to receive a first portion of the light and to generate a first output signal of the plurality of output signals; and
a second Mach-Zehnder interferometer positioned to receive a second portion of the light and to generate a second output signal of the plurality of output signals; and
a controller configured to use the plurality of output signals to control the light source to generate the light at a target wavelength, wherein:
the first Mach-Zehnder interferometer comprises:
a first set of input waveguides;
a first pair of intermediate waveguides;
a first set of output waveguides;
a first input beam splitter connecting the first set of input waveguides to the first pair of intermediate waveguides; and
a first output beam splitter connecting the first pair of intermediate waveguides to the first set of output waveguides;
the second Mach-Zehnder interferometer comprises:
a second set of input waveguides;
a second pair of intermediate waveguides;
a second set of output waveguides;
a second input beam splitter connecting the second the set of input waveguides to the second pair of intermediate waveguides; and
a second output beam splitter connecting the second pair of intermediate waveguides to the second set of output waveguides; and
a first portion of the second Mach-Zehnder interferometer is positioned between the first input beam splitter and the first output beam splitter.

10. The photonic integrated circuit of claim 9, wherein the wavelength locking unit comprises:
a third Mach-Zehnder interferometer positioned to receive a first portion of the light and to generate a third output signal of the plurality of output signals, the third Mach-Zehnder interferometer comprising:
a third set of input waveguides;
a third pair of intermediate waveguides;
a third set of output waveguides;
a third input beam splitter connecting the third the set of input waveguides to the third pair of intermediate waveguides; and
a third output beam splitter connecting the third pair of intermediate waveguides to the second set of output waveguides.

11-20. (canceled)

21. A photonic integrated circuit comprising:
a light source configured to generate light;
a wavelength locking unit configured to generate a plurality of output signals from a portion of the light; and
a controller configured to use the plurality of output signals to control the light source to generate the light at a target wavelength, wherein:
the wavelength locking unit comprises:
a splitter configured to receive and split the portion of the light and comprising:
a first splitter output; and
a second splitter output;
a two-by-three coupler configured to generate the plurality of output signals and comprising:
a first coupler input;
a second coupler input;
a first coupler output;
a second coupler output; and
a third coupler output;
a first intermediate waveguide connecting the first splitter output to the first coupler input; and
a second intermediate waveguide connecting the first splitter output to the first coupler input, wherein:
the two-by-three coupler is positioned at least partially between a first portion of the second intermediate waveguide and a second portion of the second intermediate waveguide.

22. The photonic integrated circuit of claim 21, wherein:
the splitter is positioned at least partially between the first portion of the second intermediate waveguide and the second portion of the second intermediate waveguide.

23. The photonic integrated circuit of claim 21, comprising:
a temperature sensor positioned to measure temperature at a location between the first portion of the second intermediate waveguide and the second portion of the second intermediate waveguide.

24. The photonic integrated circuit of claim 23, wherein:
the location is positioned between the two-by-three coupler and the splitter along a direction.

25. The photonic integrated circuit of claim 21, wherein:
the first portion of the second intermediate waveguide includes a first straight section and a second straight section connected by a first turn; and
the second portion of the second intermediate waveguide includes a third straight section and a fourth straight section connected by a second turn.

26. The photonic integrated circuit of claim 25, comprising:
a first set of temperature sensors positioned to measure temperature at a first set of locations between the first straight section and the second straight section; and
a second set of temperature sensors positioned to measure temperature at a second set of locations between the third straight section and the fourth straight section.

27. The photonic integrated circuit of claim 26, wherein:
the first set of temperature sensors comprises a first temperature sensor and a second temperature sensor; and
the second set of temperature sensors comprises a third temperature sensor and a fourth temperatures sensor.

28. The photonic integrated circuit of claim 21, comprising:
a first output waveguide connected to the first coupler output;
a second output waveguide connected to the second coupler output; and
a third output waveguide connected to the third coupler output.

29. The photonic integrated circuit of claim 28, wherein:
the two-by-three coupler comprises:
a first coupler waveguide connecting the first coupler input to the first coupler output; and
a second coupler waveguide connecting the second coupler input to the second coupler output; and
a third coupler waveguide connected to the third coupler output; and
the third coupler waveguide is optically coupled to each of the first coupler waveguide and the second coupler waveguide.

30. The photonic integrated circuit of claim 29, wherein:
the second portion of the second intermediate waveguide is at least partially positioned between the two-by-three coupler and a first portion of the first output waveguide.

31-40. (canceled)
